(19) United States
(12) Patent Application Publication
(10) Pub. No.: US 2025/0343569 A1
(43) Pub. Date: Nov. 6, 2025

(54) DEVICE AND METHOD FOR CONTROLLING ELECTRICAL CHARACTERISTICS OF TRANSCEIVER

(71) Applicants: Samsung Electronics Co., Ltd., Suwon-si (KR); POSTECH RESEARCH AND BUSINESS DEVELOPMENT FOUNDATION, Pohang-si (KR)

(72) Inventors: Yonghoon KIM, Suwon-si (KR); Hojin SONG, Pohang-si (KR); Daehyun KANG, Suwon-si (KR); Yuichi AOKI, Suwon-si (KR); Sunggi YANG, Suwon-si (KR); Seunghoon LEE, Pohang-si (KR); Jeongho LEE, Suwon-si (KR); Seunguk CHOI, Pohang-si (KR)

(21) Appl. No.: 19/272,587

(22) Filed: Jul. 17, 2025

Related U.S. Application Data
(63) Continuation of application No. PCT/KR2023/020894, filed on Dec. 18, 2023.

(30) Foreign Application Priority Data
Jan. 20, 2023 (KR) 10-2023-0008962
Mar. 13, 2023 (KR) 10-2023-0032706

(51) Int. Cl. H04B 1/40; H01Q 21/24; H04B 1/04

(52) U.S. Cl. CPC H04B 1/40; H01Q 21/24; H04B 1/0483; H04B 2001/0408

(57) ABSTRACT

An electronic device is provided. The electronic device includes a first radio frequency (RF) chip for transmission and reception of RF signals, wherein the first RF chip comprises a first transceiver for transmitting RF signals having first polarization and a second transceiver for transmitting RF signals having second polarization, a second RF chip for transmission and reception of RF signals, wherein the second RF chip comprises a third transceiver for transmitting RF signals having the first polarization and a fourth transceiver for transmitting RF signals having the second polarization, at least one connection line including at least one switch circuit, and electrically connecting the first RF chip and the second RF chip, and at least one processor, wherein the at least one processor is configured to control the at least one switch circuit such that a first transceiver and a fourth transceiver are electrically connected and a second transceiver and a third transceiver are electrically connected through the at least one connection line.

### CROSS-REFERENCE TO RELATED APPLICATION(S)

This application is a continuation application, claiming priority under 35 U.S.C. § 365 (c), of an International application No. PCT/KR2023/020894, filed on Dec. 18, 2023, which is based on and claims the benefit of a Korean patent application number 10-2023-0008962, filed on Jan. 20, 2023, in the Korean Intellectual Property Office, and of a Korean patent application number 10-2023-0032706, filed on Mar. 13, 2023, in the Korean Intellectual Property Office, the disclosure of each of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) Samsung Electronics Co., Ltd. and 2) Postech Research and Business Development Foundation.

### BACKGROUND

### 1. Field

The disclosure relates to a device and a method for controlling electrical characteristics of transceivers.

### 2. Description of Related Art

5^{th} generation (5G) mobile communication technologies define broad frequency bands such that high transmission rates and new services are possible, and can be implemented not only in “Sub 6 gigahertz (GHZ)” bands such as 3.5 GHZ, but also in “Above 6 GHz” bands referred to as mm Wave including 28 GHz and 39 GHz. In addition, it has been considered to implement 6^{th} generation (6G) mobile communication technologies (referred to as Beyond 5G systems) in terahertz (TH) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An electronic device (for example, a base station or a UE) may identify or estimate the electrical characteristics of transceivers connected through a connection structure (for example, a loopback) between the transceivers. For example, the electronic device may include a first transceiver and a second transceiver electrically connected through a connection line. The electronic device may identify RF signals transmitted by the first transceiver through the second transceiver, thereby identifying electrical or physical characteristics (for example, phase, intensity) regarding both the first transceiver that operates as a transmission circuit and the second transceiver that operates as a reception circuit.

Meanwhile, the electronic device cannot identify electrical or physical characteristics (for example, phase, intensity) of respective transceivers even if a connection structure (for example, a loopback structure) between the transceivers is used. Accordingly, the electronic device may have difficulty in controlling the configuration of phase shifters included in respective transceivers or controlling the configuration of power amplifiers or low-noise amplifiers (LNAs).

Aspects of the disclosure are to address at least the above-mentioned problems and/or disadvantages and to provide at least the advantages described below. Accordingly, an aspect of the disclosure is to provide a device and a method for controlling electrical characteristics of transceivers.

Additional aspects will be set forth in part in the description which follows and, in part, will be apparent from the description, or may be learned by practice of the presented embodiments.

In accordance with an aspect of the disclosure, an electronic device is provided. The electronic device includes a first radio frequency (RF) chip for transmitting and receiving RF signals, wherein the first RF chip comprises a first transceiver for transmitting RF signals having first polarization and a second transceiver for transmitting RF signals having second polarization, a second RF chip for transmitting and receiving RF signals, wherein the second RF chip comprises a third transceiver for transmitting RF signals having the first polarization and a fourth transceiver for transmitting RF signals having the second polarization, at least one connection line including at least one switch circuit, wherein the at least one connection line is configured to electrically connect the first RF chip and the second RF chip, memory, comprising one or more storage media, storing instructions, and at least one processor communicatively coupled to the first RF chip, second RF chip and memory, wherein the instructions, when executed by the at least one processor individually or collectively, cause the electronic device to control the at least one switch circuit such that, through the at least one connection line, the first transceiver and the fourth transceiver are electrically connected, and the second transceiver and the third transceiver are electrically connected, and control at least one of a first power amplifier (PA) or a first phase shifter included in the second transceiver, based on a first RF signal of the second polarization output from the fourth transceiver and received through the first transceiver, and a second RF signal of the second polarization output from the second transceiver and received through the third transceiver.

In accordance with another aspect of the disclosure, a method performed by an electronic device in a wireless communication system is provided. The method includes controlling, by the electronic device, at least one switch such that a first transceiver and a second transceiver included in a first radio frequency (RF) chip are electrically connected to a third transceiver and a fourth transceiver included in a second RF chip, respectively, through at least one connection line included in the electronic device, identifying, by the electronic device, a first RF signal of second polarization output from the fourth transceiver and received through the first transceiver, and a second RF signal of second polarization output from the second transceiver and received through the third transceiver, and controlling, by the electronic device, one of a first power amplifier (PA) or a first phase shifter included in the second transceiver, based on the first RF signal and the second RF signal, wherein the first transceiver and the third transceiver correspond to transceivers for transmitting and receiving RF signals having first polarization, and wherein the second transceiver and the fourth transceiver correspond to transceivers for transmitting and receiving RF signals having the second polarization.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations including controlling, by the electronic device, at least one switch such that a first transceiver and a second transceiver included in a first radio frequency (RF) chip are electrically connected to a third transceiver and a fourth transceiver included in a second RF chip, respectively, through at least one connection line included in the electronic device, identifying, by the electronic device, a first RF signal of second polarization output from the fourth transceiver and received through the first transceiver, and a second RF signal of second polarization output from the second transceiver and received through the third transceiver, and controlling, by the electronic device, one of a first power amplifier (PA) or a first phase shifter included in the second transceiver, based on the first RF signal and the second RF signal, wherein the first transceiver and the third transceiver correspond to transceivers for transmitting and receiving RF signals having first polarization, and wherein the second transceiver and the fourth transceiver correspond to transceivers for transmitting and receiving RF signals having the second polarization.

According to an embodiment, the electronic device uses a loopback structure so as to identify the electrical characteristics or channels of circuits of respective transceivers included in one RF chip, thereby reducing or minimizing the deviation of electrical characteristics of signals output from the transceivers included in one RF chip.

According to an embodiment, the electronic device reduces or minimizes the deviation of electrical characteristics (e.g., phase, intensity) of signals output from transceivers included in a plurality of RF chips.

According to an embodiment, power consumption for transceiver calibration and the and chip area are reduced.

According to an embodiment, the time necessary to identify the electrical characteristics of respective transceivers is reduced because there is no required detection through separate individual probes with regard to respective transceivers.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates configurations of an electronic device according to an embodiment of the disclosure;

FIG. 3 illustrates a structure of an electronic device according to an embodiment of the disclosure;

FIG. 4 is a diagram illustrating a method for identifying electrical characteristics or channels of a transceiver included in one RF chip according to an embodiment of the disclosure;

FIG. 5 is a diagram illustrating transceivers included in one RF chip according to an embodiment of the disclosure;

FIG. 6 is a diagram illustrating a method for identifying electrical characteristics of transceivers included in one RF chip according to an embodiment of the disclosure;

FIG. 7 is a diagram illustrating a connection between a first transmission line and at least one connection line according to an embodiment of the disclosure;

FIG. 8 is a diagram illustrating a connection between a first transmission line and at least one connection line according to an embodiment of the disclosure;

FIG. 9 is a diagram for describing electrical characteristics and channels of transceivers in case that transceivers for a first polarized signal and transceivers for a second polarized signal are not disposed alternately, according to an embodiment of the disclosure;

FIG. 10 is a diagram for describing electrical characteristics and channels of transceivers in case that transceivers for a first polarized signal and transceivers for a second polarized signal are not disposed alternately, according to an embodiment of the disclosure;

FIG. 11 is a diagram illustrating a method for identifying electrical characteristics and channels of transceivers disposed on different chips according to an embodiment of the disclosure;

FIG. 12 is a diagram illustrating a method for identifying electrical characteristics and channels of transceivers disposed on different chips according to an embodiment of the disclosure;

FIG. 13 is a diagram illustrating a comparison between actual characteristic values of transceivers in a first RF chip and simulation values, based on the method described with reference to FIG. 12 according to an embodiment of the disclosure;

FIG. 14 is a diagram illustrating a comparison between actual characteristic values of transceivers in a second RF chip and simulation values, based on the method described with reference to FIG. 12 according to an embodiment of the disclosure;

FIG. 15 is a diagram illustrating a comparison between actual characteristic values of transceivers included in a first RF chip and a second RF chip and simulation values, based on the method described with reference to FIG. 12 according to an embodiment of the disclosure; and

FIG. 16 is a diagram illustrating a method for identifying characteristics of transceivers included in different chips in connection with an electronic device further including a third RF chip according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

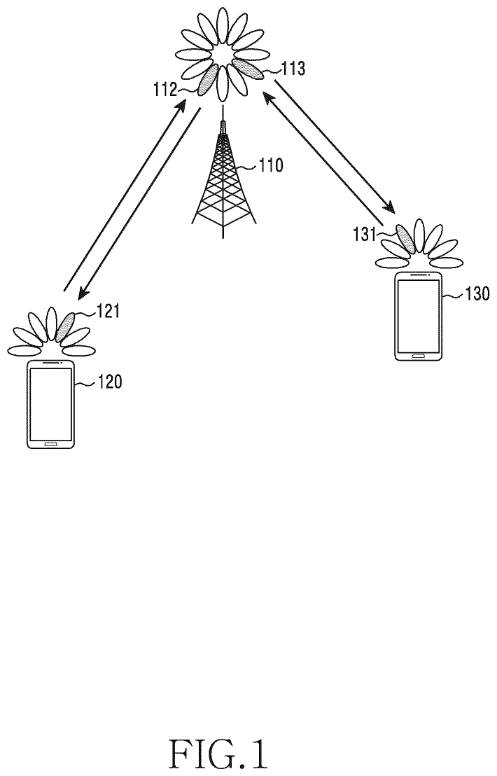

FIG. 1 illustrates a wireless communication system according to an embodiment of the disclosure.

FIG. 1 illustrates a base station 110, a user equipment (UE) 120, and a UE 130 as some of nodes using radio channels in a wireless communication system. Although FIG. 1 illustrates only one base station, other base stations identical or similar to the base station 110 may be further included.

Referring to FIG. 1, the base station 110 is a network infrastructure that provides the UEs 120 and 130 with radio access. The base station 110 has coverage defined as a certain geographical area, based on a distance over which a signal can be transmitted. The base station 110 may be referred to as an “access point (AP)”, an “eNodeB (eNB)”, a “5th generation node (5G node)”, a “wireless point”, a “transmission/reception point (TRP)”, or other terms having technical meanings equivalent thereto, as well as a base station.

According to an embodiment, each of the UE 120 and the UE 130 is a device used by a user, and performs communication with the base station 110 through a radio channel. At least one of the UE 130 and the UE 140 may be operated without involvement of a user. That is, at least one of the UE 120 and the UE 130 may be a device performing machine-type communication (MTC), and may not be carried by a user. Each of the UE 120 and the UE 130 may be referred to as a “user equipment (UE)”, a “mobile station”, a “subscriber station”, a “customer-premises equipment (CPE)”, a “remote terminal”, a “wireless terminal”, an “electronic device”, a “user device”, or other terms having technical meanings equivalent thereto, as well as a terminal.

The base station 110, the UE 120, and the UE 130 may transmit and receive wireless signals in millimeter wave (mmWave) bands (e.g., 28 GHz, 30 GHZ, 38 GHz, and 60 GHZ). In regard of this, the base station 110, the UE 120, and the UE 130 may perform beamforming in order to improve channel gain. For example, the beamforming may include transmission beamforming and reception beamforming. That is, the base station 110, the UE 120, and the UE 130 may apply directivity to transmission signals or reception signals. To this end, the base station 110 and the UEs 120 and 130 may select serving beams 112, 113, 121, and 131 via a beam search procedure or a beam management procedure. After the serving beams 112, 113, 121, and 131 are selected, subsequent communication may be performed via resources that are in quasi co-located (QCL) relationship with resources in which the serving beams 112, 113, 121, and 131 are transmitted.

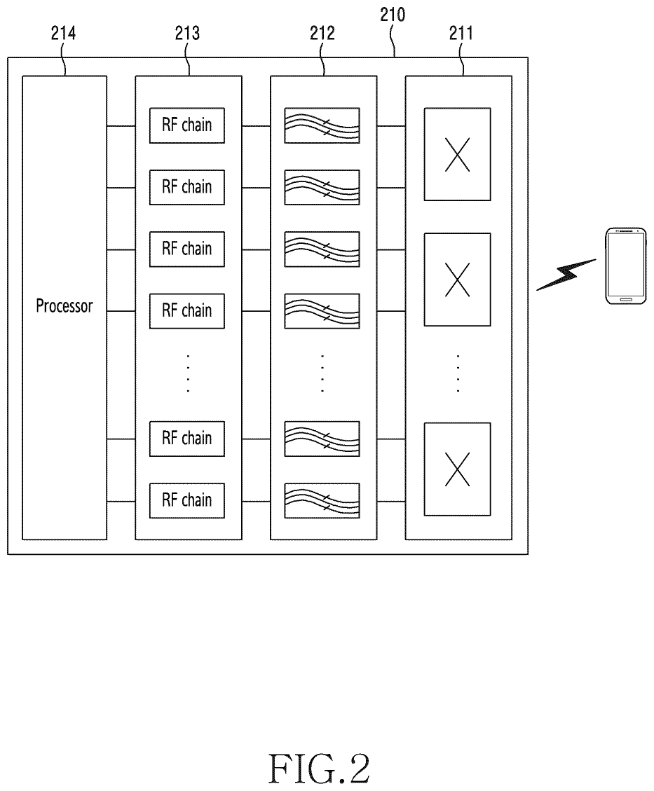

FIG. 2 illustrates configurations of an electronic device according to an embodiment of the disclosure.

Referring to FIG. 2, functional configurations of an electronic device 210 according to an embodiment is illustrated. The electronic device 210 may include an antenna unit 211, a filter unit 212, a radio frequency (RF) processor 213, and/or a controller 214.

According to an embodiment, the antenna unit 211 may include a plurality of antennas (or antenna elements). The antennas perform functions for transmitting or receiving a signal through a radio channel. The antenna may include an emitter including a conductor or conductive pattern formed on a substrate (e.g., a PCB). The antennas may radiate an up-converted signal through a radio channel or obtain a signal radiated by another device. Each of the antennas may be referred to as an antenna element or an antenna device. In an embodiment, the antenna unit 211 may include antenna arrays (e.g., sub arrays) each having an array of a plurality of antenna elements. The antenna unit 211 may be electrically connected to the filter unit 212 via RF signal lines. The antenna unit 211 may be embedded in a PCB including a plurality of antenna elements. The PCB may include a plurality of RF signal lines which connect the respective antenna elements to filters of the filter unit 212. The RF signals may be referred to as a feeding network. The antenna unit 211 may provide a received signal to the filter unit 212 or may radiate a signal provided from the filter unit 212 into the air. The antennas having a structure according to an embodiment of the disclosure may be included in the antenna unit 211.

According to an embodiment, the antenna unit 211 may include at least one antenna module having a dual-polarized antenna. The dual-polarized antenna may be, for example, a cross-pol (x-pol) antenna. The dual-polarized antenna may include two antenna elements corresponding to different polarizations. For example, the dual-polarized antenna may include a first antenna element having a polarization of +45° and a second antenna element having a polarization of −45°. Of course, the polarization may be formed by other orthogonal polarizations, in addition to +45° and −45°. Each antenna element may be connected to a feeding line, and may be electrically connected to the filter unit 212, the RF processor 213, and the controller 214 which will be described later.

According to an embodiment, the dual-polarized antenna may be a patch antenna (or microstrip antenna). The dual-polarized antenna may be in the form of a patch antenna, and thus may be easily implemented and integrated as an array antenna. Two signals having different polarizations may be input to each antenna port. Each antenna port corresponds to an antenna element. For high efficiency, it is required to optimize a relationship between co-pol characteristics and cross-pol characteristics of the two signals having different polarizations. In the dual-polarized antenna, the co-pol characteristics represent characteristics for a specific polarization component, and the cross-pol characteristics represent characteristics for the specific polarization component and other polarization components.

An antenna (e.g., an antenna element, a sub array, or an antenna array) of an antenna device including a separate type PCB according to an embodiment of the disclosure may be included in the antenna unit 211. For example, a first conductive member or the first conductive member and a second conductive member of the antenna device according to an embodiment of the disclosure may refer to an antenna element and may be included in the antenna unit 211 of FIG. 2.

According to an embodiment, the filter unit 212 may perform filtering for transmitting a signal of a desired frequency. The filter unit 212 may perform a function for selectively identifying a frequency by forming resonance. In an embodiment, the filter unit 212 may form resonance through a cavity which structurally includes a dielectric. In addition, in an embodiment, the filter unit 212 may form resonance through devices which form inductance or capacitance. In addition, in an embodiment, the filter unit 212 may include an elastic filter, such as a bulk acoustic wave (BAW) filter or a surface acoustic wave (SAW) filter. The filter unit 212 may include at least one of a band pass filter, a low pass filter, a high pass filter, or a band reject filter. That is, the filter unit 212 may include RF circuits for obtaining a signal of a frequency band for transmission or a frequency band for reception. The filter unit 212 according to an embodiment may electrically connect the antenna unit 211 and the RF processor 213.

According to an embodiment, the RF processor 213 may include a plurality of radio frequency (RF) paths. An RF path may be the unit of a path through which a signal received through an antenna or a signal radiated through an antenna passes. At least one RF path may be referred to as an RF chain. The RF chain may include a plurality of RF devices. RF elements may include an amplifier, a mixer, an oscillator, a DAC, an ADC, or the like. For example, the RF processor 213 may include an up-converter that upconverts a digital transmission signal of a baseband into a transmission frequency, and a digital-to-analog converter (DAC) that converts an upconverted digital transmission signal into an analog RF transmission signal. The up-converter and the DAC may be a part of a transmission path. The transmission path may further include a power amplifier (PA) or a coupler (or combiner). In addition, for example, the RF processor 213 may include an analog-to-digital converter (ADC) that converts an analog RF reception signal into a digital reception signal and a downconverter that converts a digital reception signal into a digital reception signal of a baseband. The ADC and the down-converter may be a part of a reception path. The reception path may further include a low-noise amplifier (LNA) or a coupler (or divider). The RF components of the RF processor may be implemented on a PCB. The antennas and the RF components of the RF processing unit may be implemented on the PCB, and filters may be repeatedly connected between PCBs to form a plurality of layers.

A radio frequency integrated circuit (RFIC) and a package board (PKG) of the antenna device including the separate type PCB according to an embodiment of the disclosure may be included in the RF processor 213 of FIG. 2. That is, the RF processor 213 may include a radio frequency integrated circuit (RFIC), as an RF device for mmWave. As described above in the disclosure, the RFIC may be formed as an RFIC chip coupled with the package board, so as to be coupled to a first PCB, or the RFIC may be directly coupled by the first PCB.

According to an embodiment, the controller 214 may control the overall operation of the electronic device 210. The controller 214 may include various modules for performing communication. The controller 214 may include at least one processor such as a modem. The controller 214 may include modules for digital signal processing. For example, the controller 214 may include a modem. In the case of data transmission, the controller 214 generates complex symbols by encoding and modulating a transmission bitstring. For example, in the case of data reception, the controller 214 restores a reception bitstring by demodulating and decoding a baseband signal. The controller 214 may perform functions of a protocol stack required by communication standards.

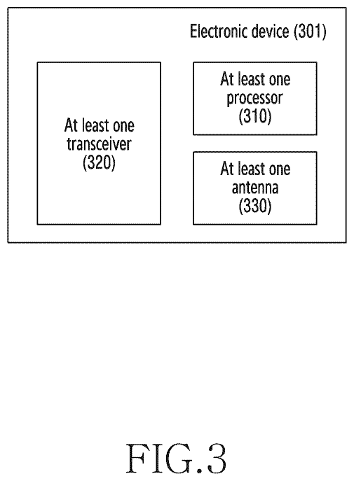

FIG. 3 illustrates a structure of an electronic device according to an embodiment of the disclosure.

Referring to FIG. 3, an electronic device 301 according to an embodiment may include at least one processor 310, at least one transceiver 320, and/or at least one antenna 330.

According to an embodiment, the at least one processor 310 may include at least one communication processor. In an embodiment, the at least one processor 310 may be electrically connected to the at least one transceiver 320 and may generate or process a signal (e.g., a baseband signal).

For example, the at least one processor 310 may transmit a signal (e.g., a baseband signal) to the at least one transceiver 320 or may receive a signal (e.g., a baseband signal) from the at least one transceiver 320.

According to an embodiment, the at least one transceiver 320 may be electrically connected to the at least one antenna 330. In an embodiment, the at least one transceiver 320 may up-convert an intermediate (IF) signal transmitted from the at least one processor 310 to a radio frequency (RF) signal, and transmit the RF signal to the at least one antenna 330.

As another example, the at least one transceiver 320 may receive an RF signal from the at least one antenna 330, down-convert the RF signal to an IF signal, and transmit the IF signal to the at least one processor 310.

According to an embodiment, the at least one transceiver 320 may include at least one transmitter and/or at least one receiver. For example, the at least one transceiver 320 may include a first transceiver including a first transmitter and a first receiver, and the at least one transceiver 320 may include a second transceiver including a first transmitter.

According to an embodiment, the at least one transceiver 320 may process, transmit, and/or receive RF signals in various frequency bands. For example, each of the first transceiver and the second transceiver included in the at least one transceiver 320 may process an RF signal in a first frequency band.

For example, the first transceiver included in the at least one transceiver 320 may process an RF signal in the first frequency band, and the second transceiver may process an RF signal in a second frequency band. As an example, the second frequency band may partially overlap with the first frequency band.

According to an embodiment, the at least one antenna 330 may include various types of antennas. For example, the at least one antenna 330 may include a patch antenna, a dipole antenna, a monopole antenna, a slit antenna, a laser direct structuring (LDS) antenna, and/or an inverted-F antenna (IFA).

For example, the at least one antenna 330 may include an antenna for transmitting and/or receiving a signal in a mmWave frequency band. For example, the at least one antenna 330 may include a plurality of antenna elements (e.g., a patch antenna), and the plurality of antenna elements may form an array. The plurality of antenna elements forming the array may transmit and/or receive a signal in the mmWave frequency band.

The term “at least one processor 310” in the disclosure may be replaced with another term referring to a configuration for data processing. For example, the term “at least one processor” may be replaced with a controller or a computing device.

In the disclosure, the at least one transceiver 320 may include a radio frequency integrated circuit (RFIC) and/or an intermediate frequency integrated circuit (IFIC). For example, in FIG. 3, the at least one transceiver 320 is described as including an RFIC and an IFIC, but this is only an example, and the at least one transceiver 320 may correspond to an RFIC. As another example, the at least one transceiver 320 may correspond to an IFIC.

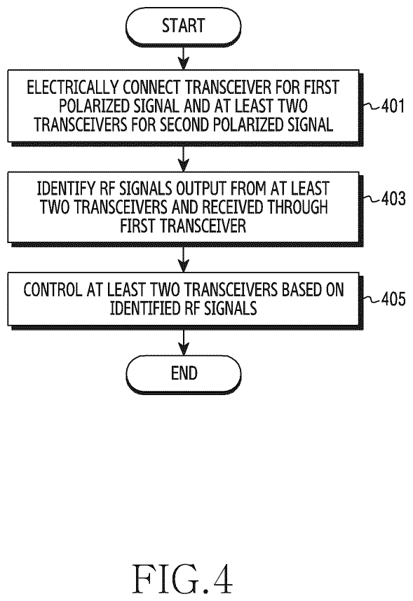

FIG. 4 is a diagram illustrating a method for identifying electrical characteristics or channels of a transceiver included in one RF chip according to an embodiment of the disclosure.

Referring to FIG. 4, the electronic device 301 according to an embodiment may connect transceivers for different polarized signals in operation 401. In an embodiment, the electronic device 301 may electrically connect a transceiver for a first polarized signal to at least two transceivers for a second polarized signal.

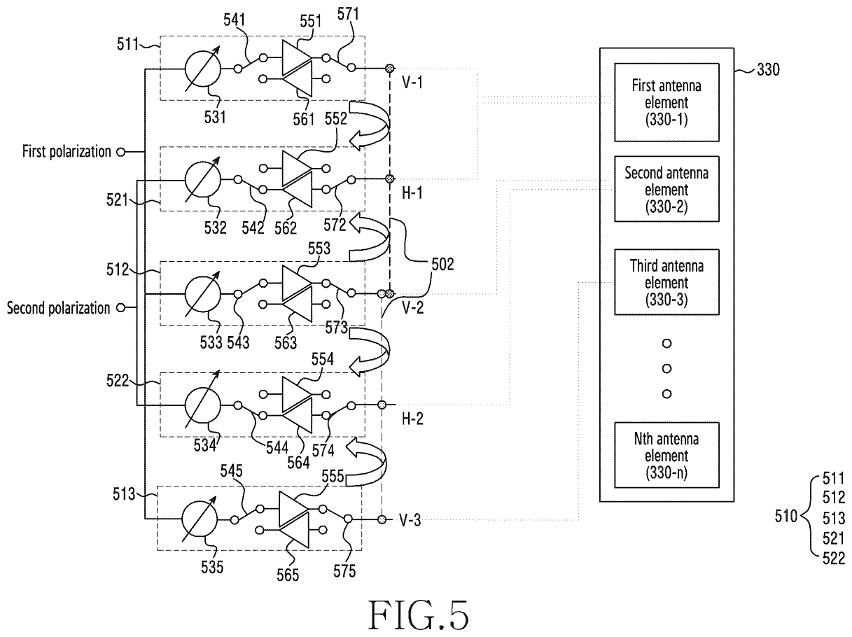

For example, the electronic device 301 may connect a first transceiver (for example, the fourth transceiver 521 in FIG. 5) for processing a first polarized signal to each of a second transceiver (for example, the first transceiver 511 in FIG. 5) and a third transceiver (for example, the second transceiver 512 in FIG. 5) for processing a second polarized signal. In an example, the first polarized signal may be a vertically polarized signal, and the second polarized signal may be a horizontally polarized signal. As another example, the first polarized signal may be a horizontally polarized signal, and the second polarized signal may be a vertically polarized signal.

According to an embodiment, the electronic device 301 may electrically or capacitively connect the output port of the first transceiver and the output port of the second transceiver through at least one connection line (or, at least one coupling line). For example, the electronic device 301 may electrically or capacitively (e.g., via coupling) connect the output port of the first transceiver and the output port of the third transceiver through at least one connection line.

According to an embodiment, in operation 403, the electronic device 301 may identify RF signals output from at least two transceivers and received through the first transceiver. For example, the at least one processor 310 may control the second transceiver so as to output a signal having second polarization, and the signal having the second polarization that has been output may be transmitted to the first transceiver through at least one connection line. For example, the at least one processor 310 may control the third transceiver so as to output a signal having second polarization, and the signal having second polarization that has been output may be transmitted to the first transceiver through at least one connection line.

In an example, the at least one processor 310 may identify a first RF signal output from the second transceiver and received (or acquired) through the first transceiver, and may identify a second RF signal output from the third transceiver and received (or acquired) through the first transceiver.

According to an embodiment, the electronic device 301 may control at least two transceivers, based on identified RF signals. For example, the at least one processor 310 may receive or identify a first RF signal and a second RF signal, and may identify the phase (or relative phase value) of the second RF signal in comparison with the phase of the first RF signal. For example, the at least one processor 310 may identify the gain (or relative gain value) of the second RF signal in comparison with the gain of the first RF signal.

In an example, the at least one processor 310 may control or adjust a phase shifter included in the second transceiver (e.g., first transceiver 511) and/or a phase shifter included in the third transceiver (e.g., second transceiver 512), based on the identified relative phase value. For example, the at least one processor 310 may change or adjust the configuration of the phase shifter included in the second transceiver and/or the configuration of the phase shifter included in the third transceiver, based on the identified relative phase value.

In an example, the at least one processor 310 may control or adjust a power amplifier (PA) included in the second transceiver and/or a PA included in the third transceiver, based on the identified relative gain value. For example, the at least one processor 310 may change or adjust the configuration of a PA and/or the configuration of an LNA included in the second transceiver, based on the identified relative gain value. The at least one processor 310 may change or adjust the configuration of a PA and/or the configuration of an LNA included in the third transceiver, based on the identified relative gain value.

A first RF signal and a second RF signal identified by the at least one processor 310 described in the disclosure may be different from a first signal and a second signal, respectively. For example, the electrical characteristics (for example, phase, signal magnitude) of a first signal output from the second transceiver may vary as the same passes through the second transceiver, at least one connection line, and the first transceiver. For example, the electrical characteristics (for example, phase, signal magnitude) of a second signal output from the third transceiver may vary as the same passes through the third transceiver, at least one connection line, and the first transceiver.

Operations 401, 403 and 405 described in the disclosure may be referred to as operations performed by at least one processor 310 of the electronic device 301.

According to an embodiment, the electronic device may use a loopback structure so as to identify the electrical characteristics or channels of circuits of respective transceivers included in one RF chip, thereby reducing or minimizing the deviation of electrical characteristics of signals output from the transceivers included in one RF chip.

According to an embodiment, the electronic device may reduce or minimize the deviation of electrical characteristics (e.g., phase, intensity) of signals output from transceivers included in a plurality of RF chips.

According to an embodiment, power consumption for transceiver calibration and the chip area may be reduced.

According to an embodiment, the time necessary to identify the electrical characteristics of respective transceivers may be reduced because there is no required detection through separate individual probes with regard to respective transceivers.

FIG. 5 is a diagram illustrating transceivers included in one RF chip according to an embodiment of the disclosure.

Referring to FIG. 5, the electronic device 301 according to an embodiment may include a plurality of transceivers 510. For example, the electronic device 301 may include a first transceiver 511, a second transceiver 512, and/or a third transceiver 513 for processing a first polarized signal (e.g., a vertically polarized signal). For example, the electronic device 301 may include a fourth transceiver 521 and/or a fifth transceiver 522 for processing a second polarized signal (for example, a horizontally polarized signal).

According to an embodiment, transceivers for processing the first polarized signal and transceivers for processing the second polarized signal may be disposed alternately.

For example, the fourth transceiver 521 for the second polarized signal may be placed below the first transceiver 511 for the first polarized signal. For example, the fourth transceiver 521 for the second polarized signal may be disposed between the first transceiver 511 and the second transceiver 512 for the first polarized signal.

For example, the second transceiver 512 for the first polarized signal may be disposed between the fourth transceiver 521 and the fifth transceiver 522. For example, the fifth transceiver 522 for the second polarized signal may be disposed between the second transceiver 512 and the third transceiver 513. For example, the third transceiver 513 for the first polarized signal may be disposed below the fifth transceiver 522.

According to an embodiment, each of the plurality of transceivers 510 may include at least one phase shifter, at least one PA, at least one low noise amplifier (LNA), and/or at least one switch. For example, the first transceiver 511 may include a first phase shifter 531, a first PA 551, a first LNA 561, a first switch 541, and/or a second switch 571. In an example, the first switch 541 may selectively connect the first phase shifter 531 to one of the first PA 551 and the first LNA 561. In an example, the second switch 571 may selectively connect one of the first PA 551 and the first LNA 561 to the first antenna element 330-1.

For example, the second transceiver 512 may include a second phase shifter 533, a second PA 553, a second LNA 563, a third switch 543, and/or a fourth switch 573. In an example, the third switch 543 may selectively connect the second phase shifter 533 to one of the second PA 553 and the second LNA 563. In an example, the fourth switch 573 may selectively connect one of the second PA 553 and the second LNA 563 to the second antenna element 330-2.

For example, the third transceiver 513 may include a third phase shifter 535, a third PA 555, a third LNA 565, a fifth switch 545, and/or a sixth switch 575. In an example, the fifth switch 545 may selectively connect the third phase shifter 535 to one of the third PA 555 and the third LNA 565. In an example, the sixth switch 575 may selectively connect one of the third PA 555 and the third LNA 565 to the third antenna element 330-3.

For example, the fourth transceiver 521 may include a fourth phase shifter 532, a fourth PA 552, a fourth LNA 562, a seventh switch 542, and/or an eighth switch 572. In an example, the seventh switch 542 may selectively connect the fourth phase shifter 532 to one of the fourth PA 552 and the fourth LNA 562. In an example, the eighth switch 572 may selectively connect one of the fourth PA 552 and the fourth LNA 562 to the first antenna element 330-1.

For example, the fifth transceiver 522 may include a fifth phase shifter 534, a fifth PA 554, a fifth LNA 564, a ninth switch 544, and/or a tenth switch 574. In an example, the ninth switch 544 may selectively connect the fifth phase shifter 534 to one of the fifth PA 554 and the fifth LNA 564. In an example, the tenth switch 574 may selectively connect one of the fifth PA 554 and the fifth LNA 564 to the second antenna element 330-2.

According to an embodiment, the plurality of transceivers 510 may be electrically connected to at least one antenna 330. For example, the first transceiver 511 for processing the first polarized signal may be electrically connected to the first antenna element 330-1. For example, the second transceiver 512 for processing the first polarized signal may be electrically connected to the second antenna element 330-2. For example, the third transceiver 513 for processing the first polarized signal may be electrically connected to the third antenna element 330-3. In an example, the first transceiver 511, the second transceiver 512, and/or the third transceiver 513 may transmit or receive RF signals having first polarization (for example, vertical polarization) by using at least one antenna 330.

For example, the fourth transceiver 521 for processing the second polarized signal may be electrically connected to the first antenna element 330-1. For example, the fifth transceiver 522 for processing the second polarized signal may be electrically connected to the second antenna element 330-2. In an example, the fourth transceiver 521 and/or the fifth transceiver 522 may transmit or receive RF signals having second polarization (e.g., horizontal polarization) by using at least one antenna 330.

Although one transceiver is described in the disclosure as being electrically connected to one antenna element, this is only an example. For example, one transceiver may be electrically connected to a plurality of antenna elements. For example, the first transceiver 511 may be electrically connected to the first antenna element 330-1 and the second antenna element 330-2.

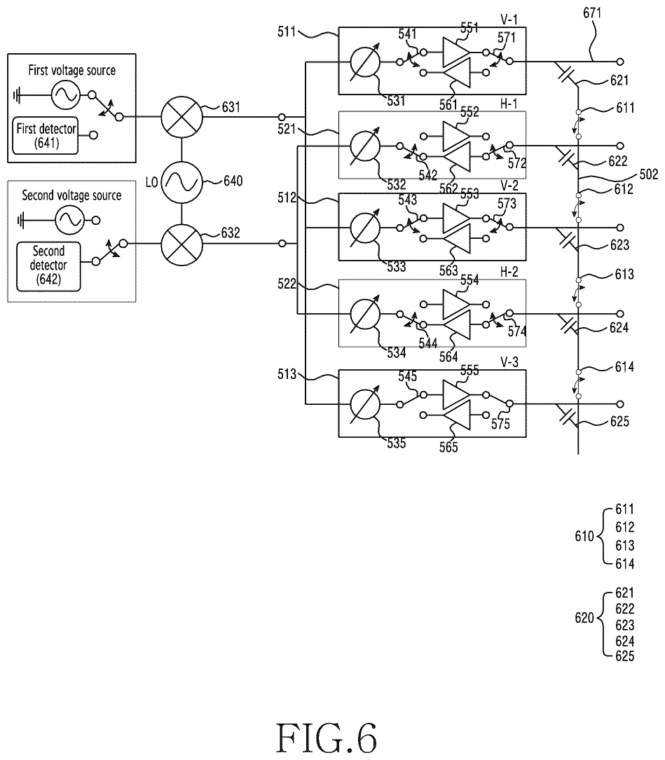

According to an embodiment, the electronic device 301 may include at least one connection line 502 for electrical connection between a plurality of transceivers 510. For example, the at least one connection line 502 may include a coupler and/or a switch circuit, and the at least one connection line 502 may connect at least two among the plurality of transceivers 510 electrically or capacitively by using the coupler and/or the switch circuit. Couplers and/or switch circuits included in the at least one connection line 502 will be described later in detail with reference to FIG. 6.

Although it has been assumed in the description of the disclosure with reference to FIG. 5 that the first polarized signal is a vertically polarized signal, and the second polarized signal is a horizontally polarized signal, this is only an example. For example, the first polarized signal may be a horizontally polarized signal, and the second polarized signal may be a vertically polarized signal. The electronic device 301 may include a first transceiver 511, a second transceiver 512, and/or a third transceiver 513 for the second polarized signal, and may include a fourth transceiver 521 and/or a fifth transceiver 522 for the first polarized signal.

In this case, the fourth transceiver 521 may receive second polarized signals from the first transceiver 511 and the second transceiver 512, respectively. The electronic device 301 may identify the relative electrical characteristics (for example, phase, intensity) between the first transceiver 511 and the second transceiver 512, based on second polarized signals received by the fourth transceiver 521, in the same manner as described above.

Hereinafter, a method for identifying electrical characteristics (e.g., phase, gain) of a transceiver through the operations described with reference to FIG. 4 will be described with reference to FIG. 6.

FIG. 6 is a diagram illustrating a method for identifying electrical characteristics of transceivers included in one RF chip according to an embodiment of the disclosure.

Referring to FIG. 6, the electronic device 301 according to an embodiment includes a first mixer 631, a second mixer 632, a local oscillator (LO) 640, a first detector 641, a second detector 642, and/or voltage sources (e.g., a first voltage source and a second voltage source).

According to an embodiment, the first mixer 631 may be referred to as a circuit for generating an IF signal having first polarization (e.g., vertical polarization).

According to an embodiment, the first mixer 631 may be electrically connected to a first transceiver 511, a second transceiver 512, and/or a third transceiver 513 for a first polarized signal (e.g., a vertically polarized signal). For example, the first mixer 631 may transmit RF signals having first polarization to the first transceiver 511, the second transceiver 512, and/or the third transceiver 513. As another example, the first mixer 631 may receive RF signals having first polarization from the first transceiver 511, the second transceiver 512, and/or the third transceiver 513, and the first mixer 631 may down-convert RF signals having first polarization into IF signals having first polarization.

According to an embodiment, the second mixer 632 may be electrically connected to a fourth transceiver 521 and/or a fifth transceiver 522 for a second polarized signal (for example, a horizontally polarized signal). For example, the second mixer 632 may transmit RF signals having second polarization to the fourth transceiver 521 and/or the fifth transceiver 522. As another example, the second mixer 632 may receive RF signals having second polarization from the fourth transceiver 521 and/or the fifth transceiver 522, and the second mixer 632 may down-convert RF signals having second polarization into IF signals having second polarization.

According to an embodiment, the LO 640 may be connected to the first mixer 631 and/or the second mixer 632, and the LO 640 may generate an AC signal and transfer the AC signal to the first mixer 631 and/or the second mixer 632.

According to an embodiment, the electronic device 301 may include at least one connection line 502, and the at least one connection line 502 may include a plurality of couplers 620. For example, the at least one connection line 502 may include a first coupler 621, a second coupler 622, a third coupler 623, a fourth coupler 624, and/or a fifth coupler 625.

According to an embodiment, the at least one connection line 502 may include a plurality of switches 610. For example, the at least one connection line 502 may include a first switch circuit 611, a second switch circuit 612, a third switch circuit 613, and/or a fourth switch circuit 614.

According to an embodiment, the first transceiver 511 may be electrically connected to the first antenna element 330-1 through a first transmission line 671.

According to an embodiment, the at least one processor 310 may electrically connect a transceiver for a first polarized signal to at least two transceivers for a second polarized signal.

For example, the at least one processor 310 may electrically connect the first transceiver 511 and the fourth transceiver 521. In an example, the first transceiver 511 and the fourth transceiver 521 may be electrically connected through the first coupler 621, the second coupler 622, and/or the first switch circuit 611.

For example, the at least one processor 310 may electrically connect the second transceiver 512 and the fourth transceiver 521. In an example, the second transceiver 512 and the fourth transceiver 521 may be electrically connected through the second coupler 622, the third coupler 623, and/or the second switch circuit 612.

According to an embodiment, the at least one processor 310 may control the first transceiver 511 and the second transceiver 512 so as to transmit RF signals having first polarization to the fourth transceiver 521. The fourth transceiver 521 may receive RF signals having first polarization from the first transceiver 511 and the second transceiver 512.

Equation 1 may be referred to as a transfer function associated with a path along which an RF signal having first polarization transferred from the first voltage source to the first transceiver 511 is transmitted to the fourth transceiver 521. Equation 2 may be referred to as a transfer function associated with a path along which an RF signal having first polarization transferred from the first voltage source to the second transceiver 512 is transmitted to the fourth transceiver 521.

$$\text{?} = \text{?} \qquad Equation 1$$

$$\text{?} = \text{?} \qquad Equation 2$$

$$\text{?} \text{indicates text missing or illegible when filed}$$

In Equation 1 and Equation 2,

$$\text{?} ( n = 1 , 2 … , N and m = 1 , 2 , … , N )$$

$$\text{?} \text{indicates text missing or illegible when filed}$$

may be referred to as a transfer function of a path along which an RF signal transmitted by a transceiver for first polarization in the RF chip (for example, channel no. m of the V-pol transmitter, V-m) is received through a transceiver for second polarization (for example, channel no. n of the H-pol receiver, H-n).

$$\text{?}$$

$$\text{?} \text{indicates text missing or illegible when filed}$$

may be referred to as a transfer function of the transceiver for second polarization (for example, channel no. n of the H-pol receiver, H-n).

$$\text{?}$$

$$\text{?} \text{indicates text missing or illegible when filed}$$

may be referred to as a transfer function of at least one connection line 502 (for example, loopback path).

$$\text{?}$$

$$\text{?} \text{indicates text missing or illegible when filed}$$

may be referred to as a transfer function of the transceiver for first polarization (for example, channel no. n of the V-pol transmitter, V-n). α is a correction coefficient, and may be referred to as a value including characteristics from a voltage source (for example, the first voltage source) to a transceiver (for example, a transmitter) and/or characteristics from the output of a transceiver (for example, a receiver) to the second detector 642 (for example, I/Q detector). V_{c} may be a single-tone or multi-tone signal coming from a voltage source (for example, a first voltage source, a second voltage source).

Equation 3 may be acquired by dividing Equation 1 by Equation 2.

$$\frac{\text{?}}{\text{?}} = \frac{\text{?}}{\text{?}} = \frac{\text{?}}{\text{?}} \qquad Equation 3$$

$$\text{?} \text{indicates text missing or illegible when filed}$$

According to an embodiment, the at least one processor 310 may acquire relative characteristics (for example, phase, gain) of the first transceiver 511 and the second transceiver 512 with reference to the fourth transceiver 521.

For example, a comparison between the transfer function of a loopback path transmitted from the second transceiver 512 (for example, channel no. 2 of the V-pol transmitter, V-2) and the transfer function of a loopback path transmitted from the third transceiver 513 (for example, channel no. 3 of the V-pol transmitter, V-3) with reference to the fifth transceiver 522 (for example, channel no. 2 of the H-pol receiver, H-2) may be expressed as in Equation 4. That is, the ratio of transfer functions in case that the fifth transceiver 522 receives RF signals from the second transceiver 512 and the third transceiver 513, respectively, may be referred to as Equation 4.

Equation 4 may be generalized such that transfer functions of loopback paths coming from transceivers (for example, channel no. m of the V-pol transmitter, V-m, and channel no. (m+1) of the V-pol transmitter, V-(m+1)) are expressed through an equation with reference to a transceiver (for example, channel no. m of the H-pol receiver, H-m), as in Equation 5.

$$\frac{\text{?}}{\text{?}} = \frac{\text{?}}{\text{?}} = \frac{\text{?}}{\text{?}} \qquad Equation 4$$

$$\frac{\text{?}}{\text{?}} = \frac{\text{?}}{\text{?}} = \frac{\text{?}}{\text{?}} \qquad Equation 5$$

$$\text{?} \text{indicates text missing or illegible when filed}$$

According to an embodiment, the at least one processor 310 may identify RF signals output from at least two transceivers and received through the fourth transceiver 521. For example, the at least one processor 310 may identify RF signals output from the first transceiver 511 and the second transceiver 512 and received through the fourth transceiver 521.

In an embodiment, the at least one processor 310 identifies RF signals received through the fourth transceiver 521, thereby identifying the ratio of

$$\text{?} and \text{?}$$

$$\text{?} \text{indicates text missing or illegible when filed}$$

in Equation 3. For example, the at least one processor 310 may identify the value of

$$\frac{\text{?}}{\text{?}}$$

$$\text{?} \text{indicates text missing or illegible when filed}$$

through RF signals received through the fourth transceiver 521, and the at least one processor 310 may consequently identify the value of

$$\frac{\text{?}}{\text{?}} .$$

$$\text{?} \text{indicates text missing or illegible when filed}$$

Likewise, the at least one processor 310 may identify the value of

$$\frac{\text{?}}{\text{?}} ( = \frac{\text{?}}{\text{?}} )$$

$$\text{?} \text{indicates text missing or illegible when filed}$$

### in Equation 5.

According to an embodiment, the at least one processor 310 may identify relative characteristics (for example, phase, gain) between the first transceiver 511 and the second transceiver 512 by using Equation 3 to Equation 5. For example, the value of

$$\frac{{V}_{m}^{Chip \#1 , Tx}}{{V}_{m + 1}^{Chip \#1 , Tx}}$$

in Equation 5 may be expressed as a complex number, and the at least one processor 310 may identify the relative phase value and/or relative gain value of an RF signal output from the second transceiver 512 in comparison with an RF signal output from the first transceiver 511, by using the value of

$$\frac{{V}_{m}^{Chip \#1 , Tx}}{{V}_{m + 1}^{Chip \#1 , Tx}}$$

expressed as a complex number.

According to an embodiment, the at least one processor 310 may control at least two transceivers, based on identified RF signals. For example, the at least one processor 310 may control the first phase shifter 531 (or the configuration of the first phase shifter 531) of the first transceiver 511, based on the identified relative phase value and/or relative gain value, and may control the second phase shifter 533 (or the configuration of the second phase shifter 533) of the second transceiver 512. For example, the at least one processor 310 may control the first PA 551 (or the configuration of the first PA 551) of the first transceiver 511 and/or the second PA 553 (or the configuration of the second PA 553) of the second transceiver 512, based on the relative phase value and/or relative gain value.

According to an embodiment, the at least one processor 310 may also identify electrical characteristics of the first transceiver 511 and/or the second transceiver 512 as receivers.

For example, the at least one processor 310 may control the fourth transceiver 521 so as to transmit RF signals to the first transceiver 511 and the second transceiver 512 in order to identify the electrical characteristics of the first transceiver 511 and/or the second transceiver 512 as receivers. In an example, the at least one processor 310 may receive RF signals transmitted by the fourth transceiver 521 through the first transceiver 511 and the second transceiver 512. The at least one processor 310 may identify relative characteristics (for example, phase, gain) of the first transceiver 511 and/or the second transceiver 512, based on the received RF signals.

$$\frac{{y}_{C 1 V ( m + 1 ) Rx \text{?} C \text{?} HmTx}^{intra}}{{y}_{C \text{?} VmRx \text{?} C \text{?} HmTx}^{intra}} = \frac{{V}_{m + 1}^{Chip \#1 , Rx} \cdot {h}_{1}^{intra} \cdot {H}_{m}^{Chip \#1 , Tx} \cdot α {V}_{s}}{{V}_{m}^{Chip \#1 , Rx} \cdot {h}_{1}^{intra} \cdot {H}_{m}^{Chip \#1 , Tx} \cdot α {V}_{s}} = \frac{{V}_{m + 1}^{Chip \#1 , Rx}}{{V}_{m}^{Chip \#1 , Rx}} \qquad Equation 7$$

$$\text{?} \text{indicates text missing or illegible when filed}$$

Equation 7 may be referred to as the transfer function of a loopback path coming through receiver no. m of the V-pol receiver/channel no. (m+1) with reference to channel no. m of the H-pol transmitter. That is, Equation 7 may be referred to as the ratio between transfer functions in case that the m^{th}-order transceiver (for example,

$${H}_{\text{?}}^{Chip \text{?}}$$

$$\text{?} \text{indicates text missing or illegible when filed}$$

for a second polarized signal transmits a second polarized signal to each of the m^{th}-order transceiver (for example,

$${V}_{m}^{\text{?}} )$$

$$\text{?} \text{indicates text missing or illegible when filed}$$

and the (m+1)^{th}-order transceiver (for example,

$${V}_{m + 1}^{\text{?} Rx} )$$

$$\text{?} \text{indicates text missing or illegible when filed}$$

for a first polarized signal. According to an embodiment, the at least one processor 310 may identify electrical characteristics (for example, phase, intensity) of the first transceiver 511 and/or the second transceiver 512 as receivers, by using Equation 7. For example, in case that m=1 in Equation 7, the value of

$$\frac{{V}_{\text{?}}^{\text{?}}}{{V}_{\text{?}}^{\text{?}}}$$

$$\text{?} \text{indicates text missing or illegible when filed}$$

may be expressed as a complex number, and the at least one processor 310 may identify the relative phase value and/or relative gain value of an RF signal received by the second transceiver 512 in comparison with an RF signal received by the first transceiver 511, by using the value of

$$\frac{{V}_{\text{?}}^{\text{?} , Rx}}{{V}_{\text{?}}^{\text{?} , Rx}}$$

$$\text{?} \text{indicates text missing or illegible when filed}$$

expressed as a complex number.

According to an embodiment, the at least one processor 310 may control or adjust at least one of LNAs or phase shifters included in the first transceiver 511 and/or the second transceiver 512, based on relative characteristics (for example, phase, gain) of the first transceiver 511 and the second transceiver 512, which operate as receivers. For example, the at least one processor 310 may control or adjust the configuration of the first LNA 561 included in the first transceiver 511. The at least one processor 310 may control or adjust the configuration of the second LNA 563 included in the second transceiver 512.

As another example, the at least one processor 310 may control or adjust the configuration of the first phase shifter 531 included in the first transceiver 511. The at least one processor 310 may control or adjust the configuration of the second phase shifter 533 included in the second transceiver 512.

The first mixer 631 and/or the second mixer 632 in the disclosure may be referred to as frequency converters which are components for up-converting IF signals to RF signals or down-converting RF signals to IF signals.

As used herein, the term “detector” may be used interchangeably with a detecting circuit, a detecting module, or a circuit for detection. For example, the first detector 641 may be used interchangeably with a first detecting circuit.

Although acquired electrical or physical characteristics of transceivers are described in the disclosure as phases or gains, this is only an example. Various electrical characteristics may be acquired through the embodiments of the disclosure described with reference to FIGS. 1 to 16.

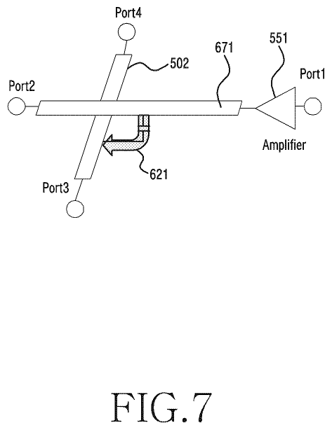

FIG. 7 is a diagram illustrating the connection between a first transmission line and at least one connection line according to an embodiment of the disclosure.

Referring to FIG. 7, the first transmission line 671 according to an embodiment may be connected to the first PA 551 of the first transceiver 511. The first PA 551 may transmit amplified signals to an antenna element (e.g., the first antenna element 330-1) through the first transmission line 671.

According to an embodiment, the at least one connection line 502 may include a first coupler 621, and the at least one connection line 502 may be electrically or capacitively connected to the first transmission line 671 through the first coupler 621.

According to an embodiment, RF signals transferred through the first transmission line 671 may be transmitted to the at least one connection line 502 through the first coupler 621.

Although the disclosure is described with reference to FIG. 7 based on an assumption that the at least one connection line 502 includes a first coupler 621, this is only an example. For example, the at least one connection line 502 and the first coupler 621 may be understood as separate components or electronic parts.

Although a capacitive coupler is illustrated in FIG. 7 of the disclosure as a component for connecting the first transmission line 671 and at least one connection line 502, this is only an example. For example, the first transmission line 671 and at least one connection line 502 may be connected by a resistive coupler.

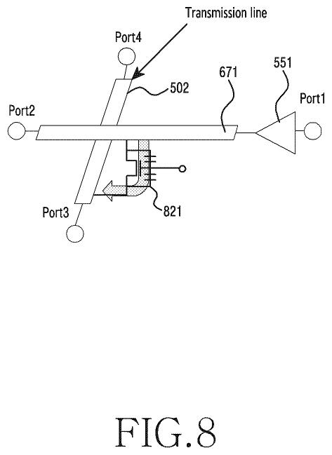

FIG. 8 is a diagram illustrating the connection between a first transmission line and at least one connection line according to an embodiment of the disclosure.

Referring to FIG. 8, the first transmission line 671 according to an embodiment may be connected to the first PA 551 of the first transceiver 511. The first PA 551 may transmit amplified signals to an antenna element (for example, the first antenna element 330-1) through the first transmission line 671.

According to an embodiment, the at least one connection line 502 may include a first MOSFET switch 821, and the at least one connection line 502 may be electrically or capacitively connected to the first transmission line 671 through the first MOSFET switch 821.

According to an embodiment, RF signals transferred through the first transmission line 671 may be transmitted to the at least one connection line 502 through the first MOSFET switch 821.

According to an embodiment, the first MOSFET switch 821 may include a serial MOSFET switch and a parallel MOSFET switch. The first MOSFET switch 821 may increase the degree of isolation between ports by using a serial MOSFET switch and a parallel MOSFET switch together.

Although the disclosure is described with reference to FIG. 8 based on an assumption that at least one connection line 502 includes a first MOSFET switch 821, this is only an example. For example, the at least one connection line 502 and the first MOSFET switch 821 may be understood as separate components or electronic parts.

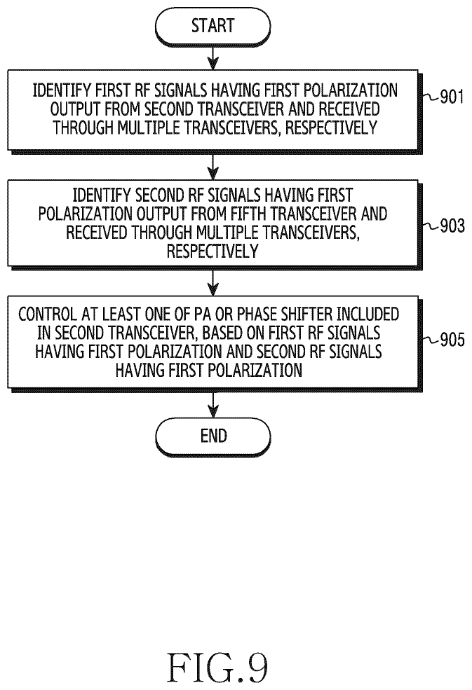

FIG. 9 is a diagram for describing electrical characteristics and channels of transceivers in case that transceivers for a first polarized signal and transceivers for a second polarized signal are not disposed alternately, according to an embodiment of the disclosure.

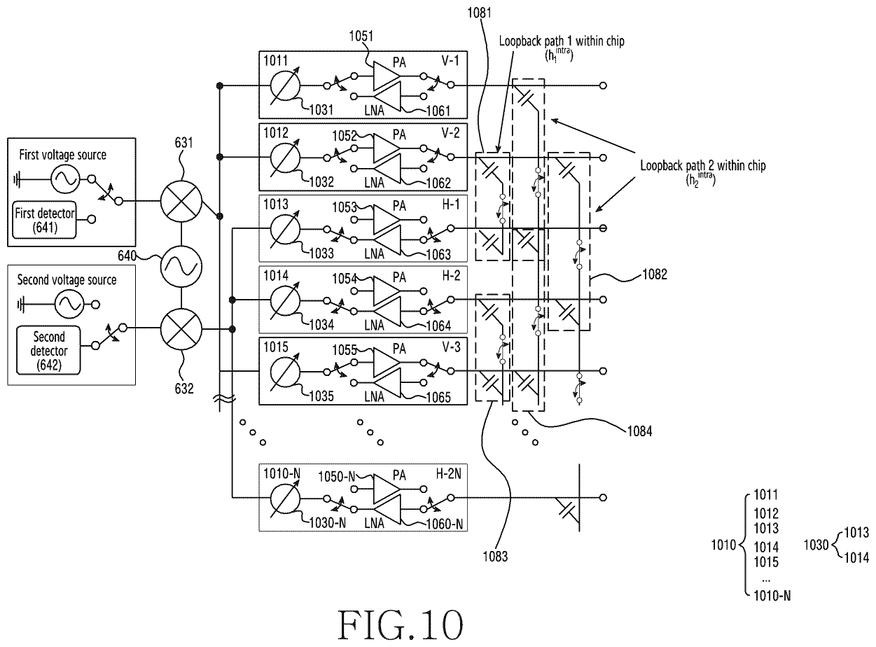

Referring to FIG. 9, in operation 901, the electronic device 301 according to an embodiment may identify first RF signals having first polarization (for example, vertical polarization) output from the second transceiver and received through a plurality of transceivers (for example, the plurality of transceivers 1030 in FIG. 10), respectively. For example, the electronic device 301 may include a second transceiver (for example, the second transceiver 1012 in FIG. 10) and a fifth transceiver (for example, the fifth transceiver 1015 in FIG. 10) for a first polarized signal. In an example, the electronic device 301 may include a plurality of transceivers (for example, a plurality of transceivers 1030) for a second polarized signal, and the plurality of transceivers may include a third transceiver (for example, the third transceiver 1013 in FIG. 10) and a fourth transceiver (for example, the fourth transceiver 1014 of FIG. 10). The electronic device 301 may identify RF signals having first polarization, which are output from the second transceiver and received through the third and fourth transceivers.

According to an embodiment, a plurality of transceivers for a second polarized signal (for example, a horizontally polarized signal) may be disposed between the second transceiver and the fifth transceiver. As a result, in the case of the transceivers described with reference to FIG. 9 of the disclosure, transceivers for a first polarized signal and transceivers for a second polarized signal may not be disposed alternately, unlike the transceivers described with reference to FIGS. 5 and 6.

According to an embodiment, in operation 903, the electronic device 301 may identify second RF signals having first polarization, which are output from the fifth transceiver and received through a plurality of transceivers, respectively. For example, the electronic device 301 may identify second RF signals having first polarization, which are output from the fifth transceiver (for example, the fifth transceiver 1015) and received through the third transceiver (for example, the third transceiver 1013) and the fourth transceiver (e.g., the fourth transceiver 1014).

Although operation 903 is described as being performed after operation 901 in the disclosure, this is for convenience of description. For example, the operation in which the electronic device 301 identifies first RF signals having first polarization in operation 901 may be performed after the operation in which the electronic device 301 identifies second RF signals having first polarization in operation 903. In conclusion, operations 901 and 903 may be performed in various orders, which do not limit the disclosure.

According to an embodiment, the electronic device 301 may control at least one of PAs and phase shifters included in the second transceiver (for example, the second transceiver 1012), based on first RF signals having first polarization and second RF signals having first polarization, in operation 905. As another example, the electronic device 301 may control at least one of PAs and phase shifters included in the fifth transceiver (for example, the fifth transceiver 1015), based on first RF signals having first polarization and second RF signals having first polarization. That is, the electronic device 301 may identify relative characteristics (for example, phase, gain) of signals output from the fifth transceiver in comparison with signals output from the second transceiver through first RF signals having first polarization and second RF signals having second polarization. The electronic device 301 may control components or electronic parts included in the second transceiver and/or the fifth transceiver, based on the identified relative characteristics. For example, components or electronic parts included in the second and/or fifth transceiver may include PAs, LNAs, phase shifters, and/or filters.

According to an embodiment, the electronic device 301 may identify the relative phase value and/or relative gain value of RF signals output from the fifth transceiver with regard to RF signals output from the second transceiver, based on first RF signals and second RF signals. In an example, the electronic device 301 may control at least one of PAs and phase shifters included in the second transceiver, based on the identified relative phase value and/or relative gain value. In an example, the electronic device 301 may control at least one of PAs and phase shifters included in the fifth transceiver, based on the identified relative phase value and/or relative gain value.

For example, the electronic device 301 may control the first PA of the second transceiver and/or a PA of the fifth transceiver such that signals output from the PA of the second transceiver and the PA of the fifth transceiver have substantially the same gain value, based on the relative gain value.

Although the electronic device 301 has been described in FIG. 9 of the disclosure as controlling PAs and/or phase shifters included in the second and fifth transceivers, respectively, based on first RF signals and second RF signals, this is only an example. For example, the electronic device 301 may control LNAs and/or phase shifters included in the third and fourth transceivers which operated as receivers, based on first RF signals and second RF signals.

According to an embodiment, the electronic device 301 may identify the relative phase value and/or relative gain value of an RF signal output from one of a plurality of transceivers (for example, a plurality of transceivers 1030) disposed between the second transceiver and the fifth transceiver with regard to an RF signal output from another transceiver among the plurality of transceivers, based on first RF signals and second RF signals. In an example, the electronic device 301 may control LNAs and/or phase shifters included in one of the plurality of transceivers, based on the identified relative phase value and/or relative gain value.

For example, the electronic device 301 may adjust or control the third transceiver (for example, the third transceiver 1013) and/or the fourth transceiver (for example, the fourth transceiver 1014) such that signals output from LNAs included in the third transceiver and signals output from LNAs included in the fourth transceiver have the same gain value, based on the identified relative gain value. As another example, the electronic device 301 may adjust or control the configuration of phase shifters included in the third transceiver and/or the configuration of phase shifters included in the fourth transceiver, based on the identified relative phase value.

Hereinafter, an example in which the electronic device 301 identifies electrical characteristics regarding respective transceivers based on operations described with reference to FIG. 9, will be described with reference to FIG. 10.

Operations 901, 903 and 905 described with reference to FIG. 9 of the disclosure may be understood as operations substantially performed by at least one processor 310 and/or transceivers of the electronic device 301.

The term “transceiver” used in the disclosure may be used interchangeably with a term for denoting a circuit including electronic parts for components for RF signal processing. For example, the transceiver may be used interchangeably with a radio frequency (RF) chain, a transmission/reception path, or a transmission/reception module.

FIG. 10 is a diagram for describing electrical characteristics and channels of transceivers in case that transceivers for a first polarized signal and transceivers for a second polarized signal are not disposed alternately, according to an embodiment of the disclosure.

Referring to FIG. 10, the electronic device 301 according to an embodiment may include a transceiver group 1010. For example, the transceiver group 1010 may include a first transceiver 1011, a second transceiver 1012, and/or a fifth transceiver 1015 for processing a first polarized signal (for example, a vertically polarized signal). For example, the transceiver group 1010 includes a third transceiver 1013, a fourth transceiver 1014, and/or an N^{th} transceiver 1010-N for processing a second polarized signal (e.g., a horizontally polarized signal).

In the disclosure, the term “transceiver groups” is used to refer to a plurality of transceivers, and may be used interchangeably with other terms that may refer to a plurality of transceivers, and does not limit the disclosure. For example, the term “transceiver groups” may be used interchangeably with transceivers or a plurality of transceivers.

According to an embodiment, the electronic device 301 may include a plurality of transceivers 1030 which process signals having the same polarization (for example, horizontal polarization), but which are not disposed alternately, among the transceiver group 1010. For example, the plurality of transceivers 1030 which process signals having the same polarization, and which are disposed adjacent to each, may include the third transceiver 1013 and/or the fourth transceiver 1014.

According to an embodiment, at least some of the transceivers for processing the first polarized signal and the transceivers for processing the second polarized signal may not be disposed alternately. For example, the second transceiver 1012 for processing the first polarized signal may be placed below the first transceiver 1011 for processing the first polarized signal. As another example, the fourth transceiver 1014 for processing the second polarization may be disposed below the third transceiver 1013 for processing the second polarization.

According to an embodiment, each of the transceiver group 1010 may include at least one phase shifter, at least one PA, at least one low noise amplifier (LNA), and/or at least one switch. For example, the first transceiver 1011 may include a first phase shifter 1031, a first PA 1051, and/or a first LNA 1061.

For example, the second transceiver 1012 may include a second phase shifter 1032, a second PA 1052, and/or a second LNA 1062. For example, the third transceiver 1013 may include a third phase shifter 1033, a third PA 1053, and/or a third LNA 1063. For example, the fourth transceiver 1014 may include a fourth phase shifter 1034, a fourth PA 1054, and/or a fourth LNA 1064. For example, the fifth transceiver 1015 may include a fifth phase shifter 1035, a fifth PA 1055, and/or a fifth LNA 1065. For example, the N^{th} transceiver 1010-N may include an N^{th} phase shifter 1010-N, an N^{th} PA 1050-N, and/or an N^{th} LNA 1060-N.

According to an embodiment, the transceiver group 1010 may be electrically connected through connection lines. For example, the second transceiver 1012 and the third transceiver 1013 may be electrically connected through the first portion 1081 of the first connection line. In an example, the first portion 1081 may include a first coupler, a second coupler, and a first switch circuit. For example, the second transceiver 1012 and the fourth transceiver 1014 may be electrically connected through the second portion 1082 of the second connection line. In an example, the second portion 1082 may include a third coupler, a fourth coupler, and a second switch circuit.

For example, the fifth transceiver 1015 and the fourth transceiver 1014 may be electrically connected through the third portion 1083 of the first connection line. In an example, the third portion 1083 may include a fifth coupler, a sixth coupler, and a third switch circuit. The fifth transceiver 1015 and the third transceiver 1013 may be electrically connected through the fourth portion 1084 of the second connection line. In an example, the fourth portion 1084 may include a seventh coupler, an eighth coupler, and a fourth switch circuit.

According to an embodiment, each of the first portion 1081 and the third portion 1083 may be referred to as loopback path 1 within the chip, and each of the first portion 1081 and the third portion 1083 may have the transfer function of h₁^{intra}. Each of the second portion 1082 and the fourth portion 1084 may be referred to as loopback path 2 within the chip, and each of the second portion 1082 and the fourth portion 1084 may have the transfer function of h₁^{intra}.

In the disclosure, the first portion 1081 and the third portion 1083 may have substantially the same transfer function. For example, the first portion 1081 may electrically connect the second transceiver 1012 and third transceiver 1013 adjacent to each other, and may have the transfer function of h₁^{intra}. Likewise, the third portion 1083 electrically connects the fourth transceiver 1014 and the fifth transceiver 1015 adjacent to each other, and may thus have the transfer function of h₁^{intra}. The descriptions that transceivers are adjacent to each other may substantially mean that transceivers are disposed such that other transceivers are not disposed between the transceivers.

Likewise, the second portion 1082 and the fourth portion 1084 may have substantially the same transfer function.

According to an embodiment, the electronic device 301 may identify electrical characteristics (for example, phase, gain) of at least four transceivers by using at least four transceivers. Hereinafter, a method for identifying electrical characteristics of four transceivers will be described based on an assumption, for example, that the four transceivers correspond to the second transceiver 1012, the third transceiver 1013, the fourth transceiver 1014, and the fifth transceiver 1015.

According to an embodiment, the electronic device 301 may identify first RF signals having first polarization, which are output from the second transceiver 1012 and received through a plurality of transceivers 1030, respectively, located between the second transceiver 1012 and the fifth transceiver 1015. For example, the plurality of transceivers 1030 may include the third transceiver 1013 and the fourth transceiver 1014.

For example, the electronic device 301 may control the second transceiver 1012 so as to transmit first RF signals having first polarization to the third transceiver 1013 and the fourth transceiver 1014. The electronic device 301 may control the fifth transceiver 1015 so as to transmit second RF signals having first polarization to the third transceiver 1013 and the fourth transceiver 1014.

The transfer function of the path along which signals transmitted from the signal source (for example, first voltage source) to the second transceiver 1012 (for example, channel no. 2 of V-pol transmitter, V-2) are received through the third transceiver 1013 (for example, channel no. 1 of H-pol receiver, H-1) within the RF chip may be referred to as Equation 8. The transfer function of the path along which signals transmitted from the signal source (for example, first voltage source) to the second transceiver 1012 (for example, channel no. 2 of V-pol transmitter, V-2) are received through the fourth transceiver 1014 (for example, channel no. 2 of H-pol receiver, H-2) may be referred to as Equation 9.

The transfer function of the path along which signals transmitted from the signal source (for example, first voltage source) to the fifth transceiver 1015 (for example, channel no. 3 of V-pol transmitter, V-3) are received through the third transceiver 1013 (for example, channel no. 1 of H-pol receiver, H-1) may be referred to as Equation 10. The transfer function of the path along which signals transmitted from the signal source (for example, first voltage source) to the fifth transceiver 1015 (for example, channel no. 3 of V-pol transmitter, V-3) are received through the fourth transceiver 1014 (for example, channel no. 2 of H-pol receiver, H-2) may be referred to as Equation 11.

$${y}_{C 1 H 1 Rx , C 1 V 2 Tx}^{intra} = {H}_{1}^{Chip \#1 , Rx} \cdot {h}_{1}^{intra} \cdot {V}_{2}^{Chip \#1 , Tx} \cdot α {V}_{s} \qquad Equation 8$$

$${y}_{C 1 H 2 Rx , C 1 V 2 Tx}^{intra} = {H}_{1}^{Chip \#1 , Rx} \cdot {h}_{2}^{intra} \cdot {V}_{2}^{Chip \#1 , Tx} \cdot α {V}_{s} \qquad Equation 9$$

$${y}_{C 1 H 1 Rx , C 1 V \text{?} Tx}^{intra} = {H}_{1}^{Chip \#1 , Rx} \cdot {h}_{2}^{intra} \cdot {V}_{\text{?}}^{Chip \#1 , Tx} \cdot α {V}_{s} \qquad Equation 10$$

$${y}_{C 1 H 2 Rx , C 1 V \text{?} Tx}^{intra} = {H}_{\text{?}}^{Chip \#1 , Rx} \cdot {h}_{1}^{intra} \cdot {V}_{\text{?}}^{Chip \#1 , Tx} \cdot α {V}_{s} \qquad Equation 11$$

$$\text{?} \text{indicates text missing or illegible when filed}$$

Respective parameters in Equation 8 to Equation 9 may be substantially identical to the parameters described with reference to FIG. 6,

$${h}_{1}^{intra}$$

may be the transfer function of loopback path 1 within the chip, and

$${h}_{2}^{intra}$$

may be the transfer function of loopback path 2 within the chip.

By performing ((Equation 8)*(Equation 9))/((Equation 10)*(Equation 11)), Equation 12 may be acquired.

$$\frac{( \text{?} 8 ) * ( \text{?} 9 )}{( \text{?} 10 ) * ( \text{?} 11 )} = \frac{{H}_{1}^{Chip \text{?} , Rx} * {H}_{2}^{Chip \text{?} , Rx} * {h}_{1}^{intra} * {h}_{2}^{intra}}{{H}_{1}^{Chip \text{?} , Rx} * {H}_{2}^{Chip \text{?} , Rx} * {h}_{2}^{intra} * {h}_{1}^{intra}} * {( \frac{{V}_{\text{?}}^{Chip \#1 , Tx}}{{V}_{\text{?}}^{Chip \#1 , Tx}} )}^{2} = {( \frac{{V}_{\text{?}}^{Chip \#1 , Tx}}{{V}_{\text{?}}^{Chip \#1 , Tx}} )}^{2} \qquad Equation 12$$

$$\text{?} \text{indicates text missing or illegible when filed}$$

According to an embodiment, the electronic device 301 may identify first RF signals having first polarization and second RF signals having first polarization, and the electronic device 301 may identify the values of

$${y}_{\text{?}}^{\text{?}} , {y}_{\text{?}}^{\text{?}} , {y}_{\text{?}}^{\text{?}} , and / or {y}_{\text{?}}^{\text{?}}$$

$$\text{?} \text{indicates text missing or illegible when filed}$$

### in Equation 8 to Equation 11.

According to an embodiment, the electronic device 301 may identify values on the left side in

$$\frac{\text{?}}{\text{?}} = {( \frac{{\text{?}}_{\text{?}}^{\text{?}}}{{\text{?}}_{\text{?}}^{\text{?}}} )}^{2}$$

$$\text{?} \text{indicates text missing or illegible when filed}$$

and, consequently, the electronic device 301 may identify a value (for example,

$${( \frac{{\text{?}}_{\text{?}}^{\text{?}}}{{\text{?}}_{\text{?}}^{\text{?}}} )}^{2} )$$

$$\text{?} \text{indicates text missing or illegible when filed}$$

that indicates relative electrical characteristics (for example, phase, gain) between transceivers (for example, the second transceiver 1012 and the fifth transceiver 1015) within the first RF chip.

Based on Equation 12, the relationship between transceivers for processing the same polarized signal (for example, first polarized signal) may be expressed by Equation 13. For example, a comparison of relative characteristics between channel no. m+1 and channel no. m+2 of the V-pol transmitter may be expressed as in Equation 13.

$$\frac{\text{?}}{\text{?}} = ( \frac{\text{?}}{\text{?}} ) , m = 1 , 2 , … , 2 N - 2 ( N \geq 2 ) \qquad Equation 13$$

$$\text{?} \text{indicates text missing or illegible when filed}$$

Likewise, based on Equation 8 to Equation 11, the relationship between transceivers for processing the same polarized signal (for example, second polarized signal) may be expressed by Equation 14. For example, a comparison of relative characteristics between channel no. m and channel no. m+1 of the H-pol transmitter, excluding channel no. 2N of the H-pol which is on the periphery, may be expressed as in Equation 14.

$$\frac{\text{?}}{\text{?}} = ( \frac{\text{?}}{\text{?}} ) \qquad Equation 14$$

$$\text{?} \text{indicates text missing or illegible when filed}$$

In Equation 13 to Equation 14, the electrical characteristics between transceivers operating as transmitters are expressed, and the electrical characteristics of transceivers operating as receivers may be likewise expressed.

For example, the electrical characteristics of the third transceiver 1013 and the fourth transceiver 1014, which are disposed between the second transceiver 1012 and the fifth transceiver 1015 operating as transmitters, may be expressed as in Equation 15. For example, a comparison of relative characteristics between channel no. m and channel no. m+1 of the H-pol receiver be expressed in Equation 15.

$$\frac{\text{?}}{\text{?}} = ( \frac{\text{?}}{\text{?}} ) \qquad Equation 15$$

$$\text{?} \text{indicates text missing or illegible when filed}$$

Likewise, the relationship between transceivers for processing the same polarized signal (for example, first polarized signal) may be expressed by Equation 16.

$$\frac{\text{?}}{\text{?}} = ( \frac{\text{?}}{\text{?}} ) , m = 1 , 2 , … , 2 N - 2 ( N \geq 2 ) \qquad Equation 16$$

$$\text{?} \text{indicates text missing or illegible when filed}$$

According to an embodiment, the electronic device 301 may identify the electrical characteristics of transceivers not located on the periphery, based on Equation 8 to Equation 16. The characteristics of transceivers located on the periphery (for example, the first transceiver 1011 and the N^{th} transceiver 1010-N) can be acquired based on Equation 17 to Equation 20.

$$( \frac{\text{?}}{\text{?}} ) = ( \frac{\text{?}}{\text{?}} ) ( \frac{\text{?}}{\text{?}} ) \qquad Equation 17$$

$$( \frac{\text{?}}{\text{?}} ) = ( \frac{\text{?}}{\text{?}} ) ( \frac{\text{?}}{\text{?}} ) \qquad Equation 18$$

$$( \frac{\text{?}}{\text{?}} ) = ( \frac{\text{?}}{\text{?}} ) ( \frac{\text{?}}{\text{?}} ) \qquad Equation 19$$

$$( \frac{\text{?}}{\text{?}} ) = ( \frac{\text{?}}{\text{?}} ) ( \frac{\text{?}}{\text{?}} ) \qquad Equation 20$$

$$\text{?} \text{indicates text missing or illegible when filed}$$

According to an embodiment, the electronic device 301 may identify the electrical characteristics of the first transceiver 1011, based on Equation 17 and Equation 18. The electronic device 301 may identify relative characteristics of the first transceiver 1011 and the second transceiver 1012 through the acquired value of

$$( \frac{\text{?}}{\text{?}} ) \text{?} ( \frac{\text{?}}{\text{?}} ) .$$

$$\text{?} \text{indicates text missing or illegible when filed}$$

According to an embodiment, the electronic device 301 may identify the electrical characteristics of the N^{th} transceiver 1010-N, based on Equation 19 and Equation 20. The electronic device 301 may identify the relative characteristics (or electrical characteristics) of the N^{th} transceiver 1010-N through the value of

$$( \frac{\text{?}}{\text{?}} ) \text{?} ( \frac{\text{?}}{\text{?}} ) .$$

$$\text{?} \text{indicates text missing or illegible when filed}$$

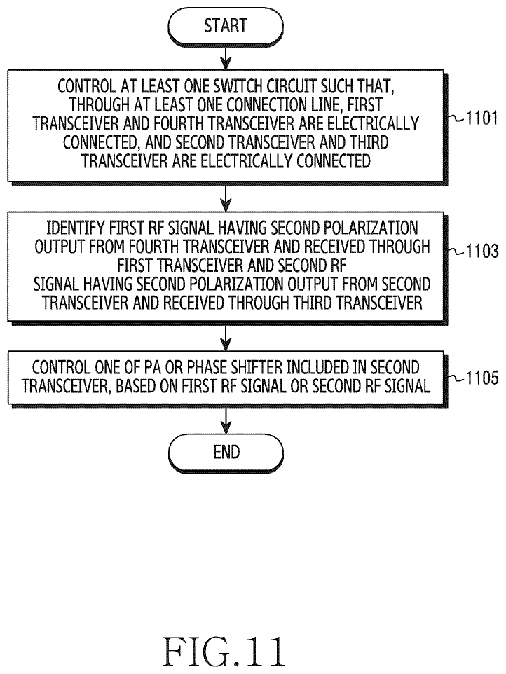

FIG. 11 is a diagram illustrating a method for identifying electrical characteristics and channels of transceivers disposed on different chips according to an embodiment of the disclosure.

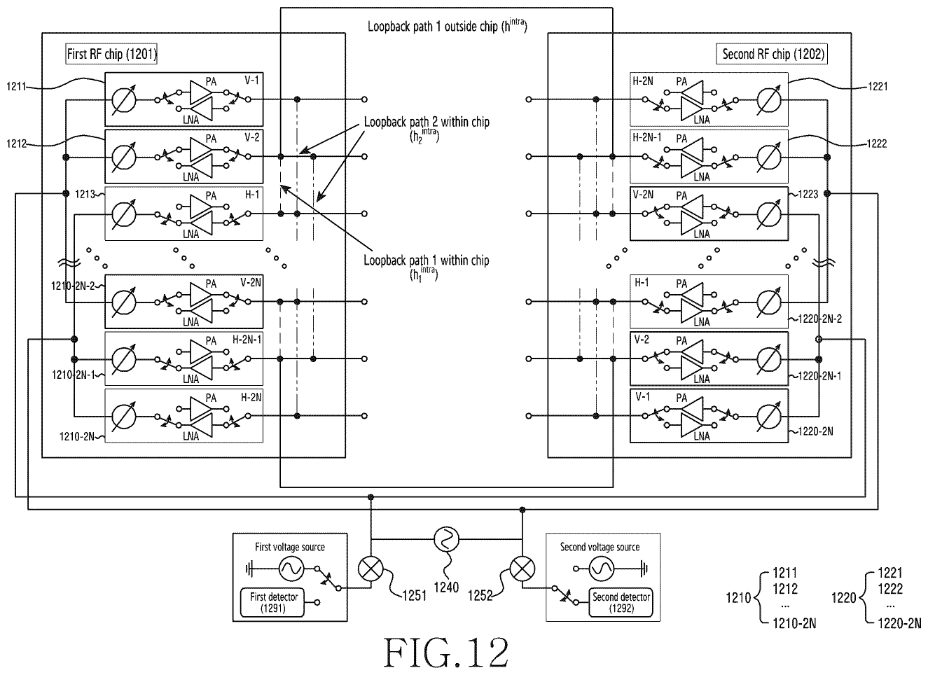

Referring to FIG. 11, the electronic device 301 according to an embodiment may control at least one switch circuit such that, through at least one connection line, the first transceiver (for example, the (1-2)^{th} transceiver 1212 in FIG. 12) and the fourth transceiver (for example, the (2-2)^{th} transceiver 1222 in FIG. 12) are electrically connected, and the second transceiver (for example, the (1−2N−1)^{th} transceiver 1210-2N−1 in FIG. 12) and the third transceiver (for example, the (2−2N−1)^{th} transceiver 1220-2N−1 in FIG. 12) are electrically connected, in operation 1101. For example, the electronic device 301 may include a first RF chip (for example, the first RF chip 1201 in FIG. 12) and a second RF chip (for example, the second RF chip 1202 in FIG. 12), and the first RF chip may include a first transceiver for processing first polarized signals and a second transceiver for processing second polarized signals. For example, the second RF chip may include a third transceiver for processing first polarized signals and a fourth transceiver for processing second polarized signals.

In an example, at least one processor 310 of the electronic device 301 may electrically connect the first transceiver included in the first RF chip and the fourth transceiver included in the second RF chip. The at least one processor 310 may electrically connect the second transceiver included in the first RF chip and the third transceiver included in the second RF chip.

According to an embodiment, the electronic device 301 may identify a first RF signal having second polarization (for example, H-pol) output from the fourth transceiver and received through the first transceiver and a second RF signal having second polarization (for example, H-pol) output from the second transceiver and received through the third transceiver in operation 1103.

For example, the at least one processor 310 may control the fourth transceiver so as to transfer a first RF signal having second polarization to the first transceiver through at least one connection line. The at least one processor 310 may identify a first RF signal having second polarization (for example, horizontal polarization) received through the first transceiver.

For example, the at least one processor 310 may control the second transceiver so as to transfer a second RF signal having second polarization to the third transceiver through at least one connection line. The at least one processor 310 may identify a second RF signal having second polarization received through the third transceiver.

According to an embodiment, the electronic device 301 may control at least one of PAs or phase shifts included in the second transceiver for processing second polarization (for example, horizontal polarization), based on a first RF signal and a second RF signal, in operation 1105. For example, the electronic device 301 may identify the relative characteristics (for example, phase, gain) of the second transceiver (for example, the (1−2N−1)^{th} transceiver 1210-2N−1) and the fourth transceiver (for example, the (2-2)^{th} transceiver 1222) for processing second polarization (for example, horizontal polarization), based on a first RF signal and a second RF signal, and the electronic device 301 may control or adjust PAs and/or phase shifters included in the second transceiver, based on the identified relative characteristics. In addition, the electronic device 301 may control or adjust PAs and/or phase shifters included in the fourth transceiver, based on the identified relative characteristics.

For example, the electronic device 301 may identify the relative characteristics (for example, phase, gain) of the first transceiver (for example, the (1−2−1)^{th} transceiver 1212) and the third transceiver (for example, the (2−2N−1)^{th} transceiver 1220-2N−1) for processing first polarization (for example, vertical polarization), based on a first RF signal and a second RF signal, and the electronic device 301 may control or adjust low noise amplifiers (LNAs) and/or phase shifters included in the first transceiver (for example, the (1−2)^{th} transceiver 1212), based on the identified relative characteristics. For example, the electronic device 301 may control or adjust LNAs and/or phase shifters included in the third transceiver (for example, the (2−2N−1)^{th} transceiver 1220-2N−1), based on the identified relative characteristics. According to an embodiment, the electronic device 301 may further perform additional operations between operations 1103 and 1105. For example, the first RF chip may further include a fifth transceiver (for example, (1−3)^{th} transceiver 1213) for transmitting RF signals having second polarization, and the second RF chip may further include a sixth transceiver (for example, (2-2N−2)^{th} transceiver 1220-2N−2) for transmitting RF signals having second polarization.

For example, the at least one processor 310 may electrically connect the first transceiver and the fifth transceiver within the first RF chip, and may electrically connect the fourth transceiver and the sixth transceiver within the second RF chip. The at least one processor 310 may identify a third RF signal having second polarization, which is output from the fifth transceiver (for example, the (1−3)^{th} transceiver 1213) and received through the first transceiver (for example, the (1−2)^{th} transceiver 1212), and a fourth RF signal having second polarization, which is output from the sixth transceiver (for example, the (2−2N−2)^{th} transceiver 1220-2N−2) and received through the third transceiver (for example, the (2−2N−1)^{th} transceiver 1220-2N−1).

For example, the at least one processor 310 may control one of PAs or phase shifters included in the second transceiver (for example, the (1−2N−1)^{th} transceiver 1210-2N−1), based on a first RF signal having second polarization, a second RF signal having second polarization, a third RF signal having second polarization, and a fourth RF signal having second polarization, transmitted between the first RF chip and the second RF chip, instead of operation 1105.

For example, the at least one processor 310 may control at least one of PAs or phase shifters included in the fourth transceiver (for example, the (2−2)^{th} transceiver 1222), based on a first RF signal having second polarization, a second RF signal having second polarization, a third RF signal having second polarization, and a fourth RF signal having second polarization, transmitted between the first RF chip and the second RF chip.

According to an embodiment, the at least one processor 310 may control at least one of LNAs or phase shifters included in the first transceiver (for example, the (1−2)^{th} transceiver 1212), based on a first RF signal having second polarization, a second RF signal having second polarization, a fifth RF signal having second polarization, and a sixth RF signal having second polarization, transmitted between the first RF chip and the second RF chip. As another example, the at least one processor 310 may control at least one of LNAs or phase shifters included in the third transceiver (for example, the (2−2N−1)^{th} transceiver 1220-2N−1), based on a first RF signal having second polarization, a second RF signal having second polarization, a fifth RF signal having second polarization, and a sixth RF signal having second polarization, transmitted between the first RF chip and the second RF chip.

According to an embodiment, the at least one processor 310 may control the first transceiver or the third transceiver, based on the first RF signal, the second RF signal, the fifth RF signal, and the sixth RF signal, in the following method.

For example, the electronic device 301 may further perform additional operations between operations 1103 and 1105. For example, the first RF chip may further include a seventh transceiver (for example, (1−2N−2)^{th} transceiver 1210-2N−2) for receiving RF signals having second polarization, and the second RF chip may further include an eighth transceiver (for example, (2−3)^{th} transceiver 1223) for receiving RF signals having second polarization.

In an example, the at least one processor 310 may electrically connect the second transceiver and the seventh transceiver within the first RF chip, and may electrically connect the fourth transceiver and the eighth transceiver within the second RF chip.

In an example, the at least one processor 310 identify a fifth RF signal having second polarization, which is output from the second transceiver (for example, the (1−2N−1)^{th} transceiver 1210-2N−1) and received through the seventh transceiver, and a sixth RF signal having second polarization, which is output from the fourth transceiver (for example, the (2−2)^{th} transceiver 1222) and received through the eighth transceiver.

In an example, the at least one processor 310 may control electrical characteristics of transceivers operating as receivers, based on the first RF signal, the second RF signal, the fifth RF signal, and/or the sixth RF signal. A method for identifying the electrical characteristics of transceivers by using transceivers included in the different RF chips described with reference to FIG. 11 will hereinafter be described with reference to FIG. 12.

Operations 1101, 1103 and 1105 described with reference to FIG. 11 may be understood as operations substantially performed by at least one processor 310 and/or transceivers of the electronic device 301.

FIG. 12 is a diagram illustrating a method for identifying electrical characteristics and channels of transceivers arranged on different chips according to an embodiment of the disclosure.

Referring to FIG. 12, the electronic device 301 according to an embodiment may include a first RF chip 1201 and a second RF chip 1202. In an embodiment, the first RF chip 1201 and the second RF chip 1202 may transmit and/or receive RF signals in substantially the same frequency band (for example, FR2 band). As another example, the first RF chip 1201 may transmit and/or receive RF signals in a first frequency band, and the second RF chip 1202 may transmit and/or receive RF signals in a second frequency band. The first frequency band and the second frequency band need only to partially overlap.

According to an embodiment, the electronic device 301 may further include a printed circuit board. At least one processor 310 for driving RF chips, the first RF chip 1201, and the second RF chip 1202 may be disposed on the first surface of the printed circuit board. At least one connection line may be formed on the first surface of the printed circuit board so as to electrically connect the first RF chip 1201 and the second RF chip 1202.

According to an embodiment, the first RF chip 1201 may include a plurality of first transceivers 1210. For example, the first transceivers 1210 of the first RF chip 1201 may include a (1−1)^{th} transceiver 1211, a (1−2)^{th} transceiver 1212, . . . , and/or a (1−2N−2)^{th} transceiver 1210-2N−2 for processing a first polarized signal (for example, a vertically polarized signal). For example, the first transceivers 1210 of the first RF chip 1201 may include a (1−3)^{th} transceiver 1213, . . . , a (1−2N−1)^{th} transceiver 1210-2N−1, and/or a (1−2N)^{th} transceiver 1210-2N for processing a second polarized signal (for example, a horizontally polarized signal).

According to an embodiment, the second RF chip 1202 may include a plurality of second transceivers 1220. For example, the second transceivers 1220 of the second RF chip 1202 may include a (2−3)^{th} transceiver 1223, a (2−2N−1)^{th} transceiver 1220-2N−1, . . . , and/or a (2−2N)^{th} transceiver 1220-2N for processing a first polarized signal. The second transceivers 1220 of the second RF chip 1202 may include a (2−1)^{th} transceiver 1221, a (2−2)^{th} transceiver 1222, . . . , a (2−2N−2)^{th} transceiver 1220-2N−2 for processing a second polarized signal.

According to an embodiment, the electronic device 301 may include an LO 1240 and a first mixer 1251 and a second mixer 1252 connected to the LO 1240. The LO 1240 may correspond to the LO 640, and the first mixer 1251 and the second mixer 1252 may correspond to the first mixer 651 and the second mixer 652, respectively. In an embodiment, the electronic device 301 may include a first detector 1291 and a second detector 1292, and the first detector 1291 and the second detector 1292 may correspond to the first detector 641 and the second detector 642, respectively.

According to an embodiment, each of the plurality of first transceivers 1210 may include at least one phase shifter, at least one PA, at least one low noise amplifier (LNA), and/or at least one switch. In an embodiment, each of the plurality of second transceivers 1220 may include at least one phase shifter, at least one PA, at least one LNA, and/or at least one switch.

According to an embodiment, the electronic device 301 may identify a first RF signal having second polarization (for example, horizontal polarization), which is output from the (2−2)^{th} transceiver 1222 of the second RF chip 1202 and received through the (1−2)^{th} transceiver 1212. The electronic device 301 may identify a second RF signal having second polarization, which is output from the (1−2N−1)^{th} transceiver 1210-2N−1 and received through the (2−2N−1)^{th} transceiver 1220-2N−1.

According to an embodiment, the electronic device 301 may identify a third RF signal having second polarization, which is output from the (1−3)^{th} transceiver 1213 and received through the (1−2)^{th} transceiver 1212. The electronic device 301 may identify a fourth RF signal having second polarization, which is output from the (2−2N−2)^{th} transceiver 1220-2N−2 and received through the (2−2N−1)^{th} transceiver 1220-2N−1.

According to an embodiment, the transfer function of the path along which the (1−2)^{th} transceiver 1212 of the first RF chip 1201 (for example, channel no. 2 of the vertical (V)-pol receiver of chip 1, V-2 of the first RF chip) receives signals transmitted by the (2-2)^{th} transceiver 1222 of the second RF chip 1202 (for example, channel no. 2N−1 of the H-pol transmitter, H-2N−1 of the second RF chip) may be referred to as Equation 22. The transfer function of the path along which the (2-2N−1)^{th} transceiver 1220-2N−1 of the second RF chip 1202 (for example, channel no. 2 of the V-pol receiver of chip 2, V-2 of the second RF chip) receives signals transmitted by the (1−2N−1)^{th} transceiver 1210-2N−1 of the first RF chip 1201 (for example, channel no. 2N−1 of the H-pol transmitter of chip 1, H-2N−1 of the first RF chip) may be referred to as Equation 24.

According to an embodiment, the transfer function of the path along which the (1−2)^{th} transceiver 1212 of the first RF chip 1201 (for example, channel no. 2 of the V-pol receiver of chip 1, V-2 of the first RF chip) receives signals transmitted by the (1−3)^{th} transceiver 1213 of the first RF chip 1201 (for example, channel no. 1 of the horizontal (H)-pol transmitter of chip 1, H-1 of the first RF chip) may be referred to as Equation 21. The transfer function of the path along which the (2−2N−1)^{th} transceiver 1220-2N−1 of the second RF chip 1202 (for example, channel no. 2 of the V-pol receiver, V-2 of the second RF chip) receives signals transmitted by the (2−2N−2)^{th} transceiver 1220-2N−2 of the second RF chip 1202 (for example, channel no. 1 of the H-pol transmitter of chip 2 H-1 of the second RF chip) may be referred to as Equation 23.

$$\text{?} = \text{?} \qquad Equation 21$$

$$\text{?} = \text{?} \qquad Equation 22$$

$$\text{?} = \text{?} \qquad Equation 23$$

$$\text{?} = \text{?} \qquad Equation 24$$

$$\text{?} \text{indicates text missing or illegible when filed}$$

In Equation 21 to Equation 24,

$$\text{?} ( k = 1 , 2 , n = 1 , 2 , … , 2 N , and m = 1 , 2 , … , 2 N )$$

$$\text{?} \text{indicates text missing or illegible when filed}$$

may be the transfer function of the path along which signals are sent within chip k, and signals are received through channel no. m of the H-pol transmitter and channel no. n of the V-pol receiver.

$$\text{?} ( l = 1 , 2 , k = 1 , 2 , n = 1 , 2 , … , 2 N , and m = 1 , 2 , … , 2 N )$$

$$\text{?} \text{indicates text missing or illegible when filed}$$

may be the transfer function of the path along which signals from channel no. m of the H-pol transmitter of chip k are received through channel no. n of the V-pol receiver of chip l.

$$\text{?}$$

$$\text{?} \text{indicates text missing or illegible when filed}$$

may be the transfer function of a loopback path outside the chip.

The electronic device 301 may acquire Equation 25 by using Equation 1 to Equation 24.

$$\frac{\text{?}}{\text{?}} = ( \frac{\text{?}}{\text{?}} ) \cdot ( \frac{\text{?}}{\text{?}} ) = ( \frac{\text{?}}{\text{?}} ) \cdot ( \frac{\text{?}}{\text{?}} ) \qquad Equation 25$$

$$\text{?} \text{indicates text missing or illegible when filed}$$

According to an embodiment,

$$\text{?} and \text{?}$$

$$\text{?} \text{indicates text missing or illegible when filed}$$

may be calculated through Equations 13-20 as the relative characteristics of channel no. 2N−1 in comparison with channel no. 1 of the H-pol transmitter within RF chips, respectively. In conclusion, the relative characteristics of transceivers operating as transmitters between RF chips may be determined as in Equation 26.

$$( \frac{\text{?}}{\text{?}} ) = \frac{\text{?}}{\text{?}} \cdot ( \frac{\text{?}}{\text{?}} ) \qquad Equation 26$$

$$\text{?} \text{indicates text missing or illegible when filed}$$

According to an embodiment, the electronic device 301 may identify the relative characteristics of first polarization (e.g., V-pol) and second polarization (e.g., H-pol) between RF chips in a similar manner, based on (or, using) Equation 27 to Equation 29.

$$( \frac{\text{?}}{\text{?}} ) = \frac{\text{?}}{\text{?}} \cdot ( \frac{\text{?}}{\text{?}} ) \qquad Equation 27$$

$$( \frac{\text{?}}{\text{?}} ) = \frac{\text{?}}{\text{?}} \cdot ( \frac{\text{?}}{\text{?}} ) \qquad Equation 28$$

$$( \frac{\text{?}}{\text{?}} ) = \frac{\text{?}}{\text{?}} \cdot ( \frac{\text{?}}{\text{?}} ) \qquad Equation 29$$

$$\text{?} \text{indicates text missing or illegible when filed}$$

According to an embodiment, the electronic device 301 may acquire electrical characteristics (for example, phase, gain) of at least two or at least four transceivers, based on at least two or at least four transceivers included in different RF chips.

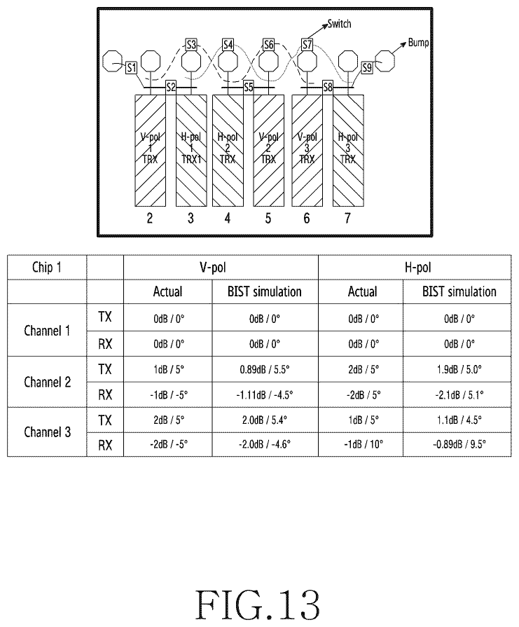

FIG. 13 is a diagram illustrating a comparison between actual characteristic values of transceivers in the first RF chip and simulation values, based on the method described with reference to FIG. 12 according to an embodiment of the disclosure.

FIG. 13 illustrates a table of comparison between electrical characteristic values actually measured from the first channel (for example, first TRx), the second channel (for example, second TRx), and the third channel (for example, third TRx) regarding each of first polarization (for example, V-pol) and second polarization (for example, H-pol), included in the first RF chip 1201 according to an embodiment, and valued derived as a result of simulation based on the method described with reference to FIG. 12. It is identified from the table of comparison that, in comparison with the actually measured electrical characteristic values, there are errors of about 0.2 dB and errors of about 0.5 degree, and that there are insignificant differences between the actual measurement values and the simulation values determined based on the method described with reference to FIG. 12. That is, it is identified that the electrical characteristics of transceivers estimated based on the method described with reference to FIG. 12 are substantially identical to the actual electrical characteristics of the transceivers.

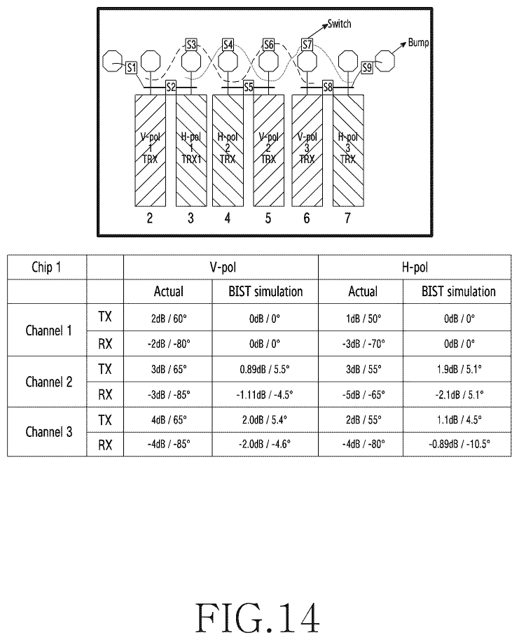

FIG. 14 is a diagram illustrating a comparison between actual characteristic values of transceivers in the second RF chip and simulation values, based on the method described with reference to FIG. 12 according to an embodiment of the disclosure.

FIG. 14 illustrates a table of comparison between electrical characteristic values actually measured from the first channel (for example, first TRx), the second channel (for example, second TRx), and the third channel (for example, third TRx) regarding each of first polarization (for example, V-pol) and second polarization (for example, H-pol), included in the second RF chip 1202 according to an embodiment, and valued derived as a result of simulation based on the method described with reference to FIG. 12. It is identified from the table of comparison that, in comparison with the actually measured electrical characteristic values, there are errors of about 0.2 dB and errors of about 0.5 degree, and that there are insignificant differences between the actual measurement values and the simulation values determined based on the method described with reference to FIG. 12. That is, it is identified that the electrical characteristics of transceivers estimated based on the method described with reference to FIG. 12 are substantially identical to the actual electrical characteristics of the transceivers.

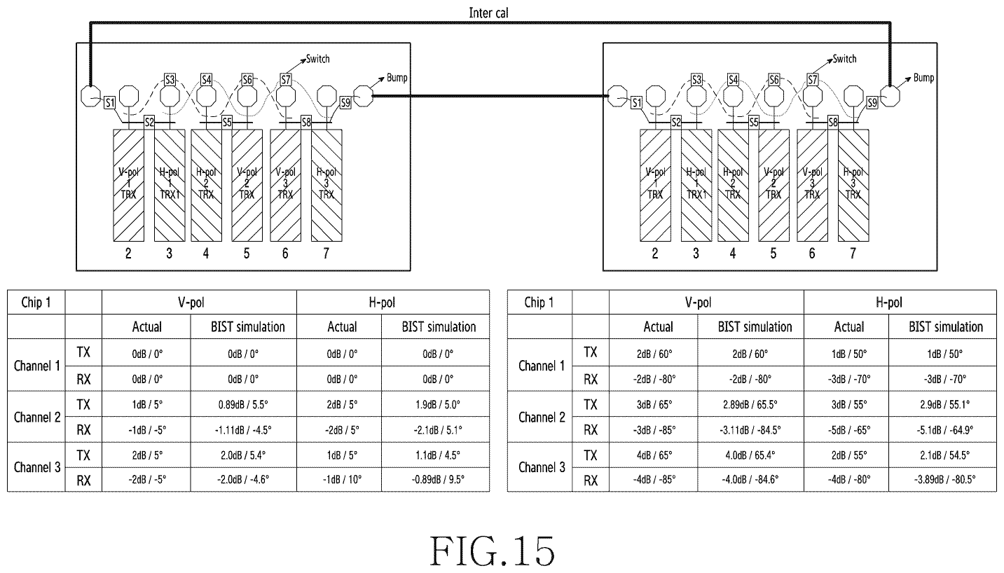

FIG. 15 is a diagram illustrating a comparison between actual characteristic values of transceivers in a first RF chip and a second RF chip and simulation values, based on the method described with reference to FIG. 12 according to an embodiment of the disclosure.

FIG. 15 illustrates a table of comparison between electrical characteristic values actually measured from the first channel (for example, first TRx), the second channel (for example, second TRx), and the third channel (for example, third TRx) regarding each of first polarization (for example, V-pol) and second polarization (for example, H-pol), included in different chips (for example, the first RF chip and second RF chip) according to an embodiment, and valued derived as a result of simulation based on the method described with reference to FIG. 12. It is identified from the table of comparison that, in comparison with the actually measured electrical characteristic values, there are errors of about 0.2 dB and errors of about 0.5 degree, and that there are insignificant differences between the actual measurement values and the simulation values determined based on the method described with reference to FIG. 12. That is, it is identified that the electrical characteristics of transceivers estimated based on the method described with reference to FIG. 12 are substantially identical to the actual electrical characteristics of the transceivers.

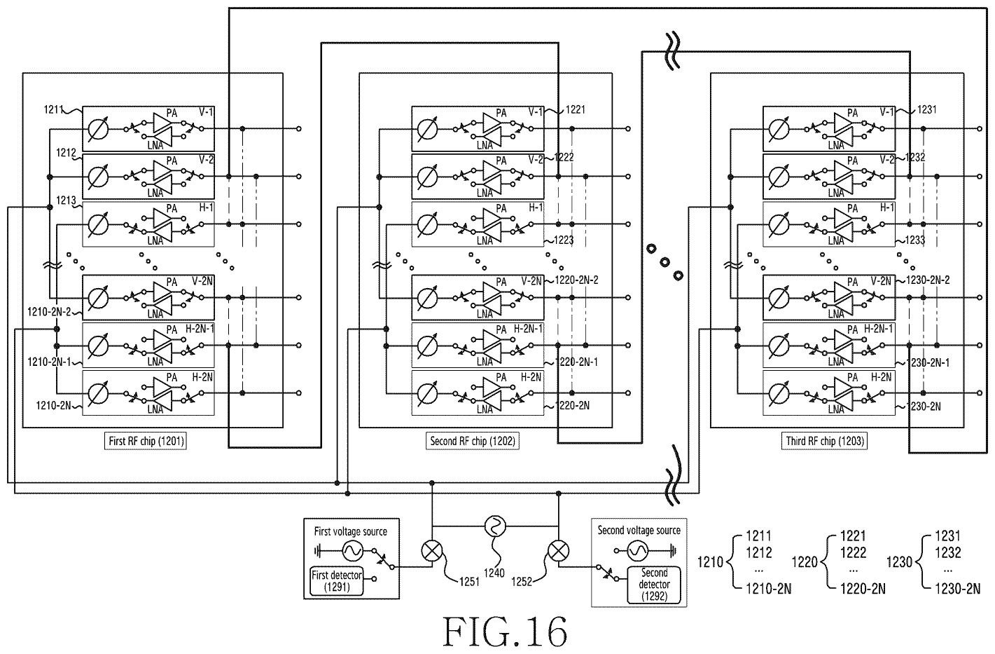

FIG. 16 is a diagram illustrating a method for identifying characteristics of transceivers included in different chips in connection with an electronic device further including a third RF chip according to an embodiment of the disclosure.

Referring to FIG. 16, the electronic device 301 according to an embodiment may further include a third RF chip 1203. For example, the electronic device 301 may include a first RF chip 1201, a second RF chip 1202, and a third RF chip 1203.

According to an embodiment, the third RF chip 1203 may transmit and/or receive RF signals in substantially the same frequency band (for example, mmWave frequency band) as the first RF chip 1201 and/or the second RF chip 1202. As another example, the third RF chip 1203 may transmit and/or receive RF signals in a frequency band that at least partially overlaps the frequency band processed by the first RF chip 1201 or the second RF chip 1202.

According to an embodiment, the third RF chip 1203 may include a plurality of third transceivers 1230. For example, the third RF chip 1203 may include a (3−1)^{th} transceiver 1231, a (3−2)^{th} transceiver 1232, . . . , a (3−2N−2)^{th} transceiver 1230-2N−2 for processing a first polarized signal (for example, a vertically polarized signal). For example, the third RF chip 1203 may include a (3−3)^{th} transceiver 1233, . . . a (3−2N−1)^{th} transceiver 1230-2N−1 and/or a (3−2N)^{th} transceiver 1230-2N for processing a second polarized signal (for example, a horizontally polarized signal).

According to an embodiment, each of the plurality of third transceivers 1230 may include at least one phase shifter, at least one PA, at least one low noise amplifier (LNA), and/or at least one switch.

According to an embodiment, the electronic device 301 may substantially apply the operation of identifying characteristics of transceivers included in the first RF chip 1201 and the second RF chip 1202 described with reference to FIGS. 11 and 12 to the first RF chip 1201 and the third RF chip 1203 as well. Therefore, the electronic device 301 may identify relative characteristics between transceivers included in the first RF chip 1201 and the second RF chip 1202.

According to an embodiment, the electronic device 301 may substantially apply the operation of identifying characteristics of transceivers included in the first RF chip 1201 and the second RF chip 1202 described with reference to FIGS. 11 and 12 to the second RF chip 1202 and the third RF chip 1203 as well. Therefore, the electronic device 301 may identify relative characteristics between transceivers included in the second RF chip 1202 and the third RF chip 1203.

An electronic device according to an embodiment may include a first RF chip for transmitting and receiving radio frequency (RF) signals, a second RF chip for transmitting and receiving RF signals, at least one connection line which includes at least one switch circuit and is configured to electrically connect the first RF chip and the second RF chip, and at least one processor. The at least one processor may be configured to control the at least one switch circuit such that, through the at least one connection line, the first transceiver and the fourth transceiver are electrically connected, and the second transceiver and the third transceiver are electrically connected. The at least one processor may be configured to control at least one of a first power amplifier (PA) or a first phase shifter included in the second transceiver, based on a first RF signal of the second polarization output from the fourth transceiver and received through the first transceiver, and a second RF signal of the second polarization output from the second transceiver and received through the third transceiver. The first RF chip may include a first transceiver for transmitting RF signals having first polarization and a second transceiver for transmitting RF signals having second polarization. The second RF chip may include a third transceiver for transmitting RF signals having the first polarization and a fourth transceiver for transmitting RF signals having the second polarization.

According to an embodiment, the first RF chip may further include a fifth transceiver for transmitting RF signals having the second polarization, and the second RF chip may further include a sixth transceiver for transmitting RF signals having the second polarization. The at least one processor may be configured to: electrically connect the first transceiver and the fifth transceiver and electrically connect the third transceiver and the sixth transceiver; identify a third RF signal of the second polarization output from the fifth transceiver and received through the first transceiver, and a fourth RF signal of the second polarization output from the sixth transceiver and received through the third transceiver; and control at least one of the first PA or the first phase shifter included in the second transceiver, based on the first RF signal, the second RF signal, the third RF signal, and the fourth RF signal transmitted between the first RF chip and the second RF chip.

According to an embodiment, the at least one processor may be configured to control at least one of a first low noise amplifier (LNA) or a second phase shifter included in the first transceiver, based on the first RF signal of the second polarization and the second RF signal of the second polarization, or control at least one of a second LNA or a third phase shifter included in the third transceiver.

According to an embodiment, the at least one processor may be configured to, based on the first RF signal and the second RF signal, identify a relative phase value of an RF signal output from the fourth transceiver with regard to a phase value an RF signal output from the second transceiver; identify a relative gain value of an RF signal output from the fourth transceiver with regard to a gain value of an RF signal output from the second transceiver; and control at least one of the first PA or the first phase shifter included in the second transceiver, based on the identified phase value and the gain value.

According to an embodiment, a first frequency band supported by the first RF chip and a second frequency band supported by the second RF chip may overlap at least partially.

According to an embodiment, the electronic device may further include a first mixer for the first polarization, a second mixer for the second polarization, and a local oscillator (LO) connected to the first mixer and the second mixer. The first mixer may be connected to the first transceiver of the first RF chip and the third transceiver of the second RF chip and configured to transmit RF signals of the first polarization to the first transceiver and the third transceiver. The second mixer may be connected to the second transceiver of the second RF chip and the fourth transceiver of the second RF chip and configured to transmit RF signals of the second polarization to the second transceiver and the fourth transceiver.

According to an embodiment, the electronic device may further include a circuit for detecting RF signals output from the first RF chip and the second RF chip. The circuit may be configured to detect the first RF signal through the first transceiver, the third transceiver, and the second mixer in case that the second mixer is connected to the circuit, and detect the second RF signal through the second transceiver, the fourth transceiver, and the first mixer in case that the first mixer is connected to the circuit.

According to an embodiment, the electronic device may further include a first antenna array and a second antenna array each including a plurality of antenna elements. Transceivers included in the first RF chip may be configured to transmit RF signals of the first polarization received from the first mixer and RF signals of the second polarization received from the second mixer to the first antenna array. Transceivers included in the second RF chip may be configured to transmit RF signals of the first polarization received from the first mixer and RF signals of the second polarization received from the second mixer to the second antenna array.

According to an embodiment, the first RF chip may include a fifth transceiver for transmitting RF signals having the first polarization, and a plurality of transceivers disposed between the first transceiver and the fifth transceiver and configured to transmit RF signals having the second polarization.

According to an embodiment, the at least one processor may identify first RF signals of the first polarization output from the first transceiver and received through the plurality of transceivers, respectively, and may identify second RF signals of the first polarization output from the fifth transceiver and received through the plurality of transceivers, respectively. The at least one processor may be configured to, based on the first RF signals of the first polarization and the second RF signals of the first polarization, identify a relative phase value and/or a relative gain value of an RF signal output from the fifth transceiver with regard to an RF signal output from the first transceiver, and identify a relative phase value and/or a relative gain value of an RF signal output from one of the plurality of transceivers with regard to an RF signal output from another among the plurality of transceivers.

According to an embodiment, the at least one processor may, based on the relative phase value and/or the relative gain value of the RF signal output from the fifth transceiver with regard to the RF signal output from the first transceiver, control at least one of a second PA or a second phase shifter included in the first transceiver, or control at least one of a third PA or a third phase shifter included in the fifth transceiver.

According to an embodiment, the at least one connection line may include a first coupler configured to capacitively connect the first transceiver and the at least one connection line, and a second coupler configured to capacitively connect the second transceiver and the at least one connection line.

According to an embodiment, the first phase shifter of the second transceiver may be selectively connected to the first PA or a low noise amplifier (LNA) included in the second transceiver.

According to an embodiment, the electronic device may further include a printed circuit board. The at least one processor, the first RF chip, and the second RF chip may be disposed on a first surface of the printed circuit board. The at least one connection line may be formed on the first surface of the printed circuit board so as to electrically connect the first RF chip and the second RF chip.

A method performed by an electronic device in a wireless communication system according to an embodiment of the disclosure may include: an operation of controlling at least one switch such that a first transceiver and a second transceiver included in a first radio frequency (RF) chip are electrically connected to a third transceiver and a fourth transceiver included in a second RF chip, respectively, through at least one connection line included in the electronic device; an operation of identifying a first RF signal of second polarization output from the fourth transceiver and received through the first transceiver, and a second RF signal of second polarization output from the second transceiver and received through the third transceiver; and an operation of controlling at least one of a first power amplifier (PA) or a first phase shifter included in the second transceiver, based on the first RF signal and the second RF signal. The first transceiver and the third transceiver may correspond to transceivers for transmitting and receiving RF signals having first polarization. The second transceiver and the fourth transceiver may correspond to transceivers for transmitting and receiving RF signals having the second polarization.

According to an embodiment, the method may include an operation of electrically connecting the first transceiver and a fifth transceiver included in the first RF chip, and electrically connect the third transceiver and a sixth transceiver included in the second RF chip; an operation of identifying a third RF signal of the second polarization output from the fifth transceiver and received through the first transceiver, and a fourth RF signal of the second polarization output from the sixth transceiver and received through the third transceiver; and an operation of controlling at least one of the first PA or the first phase shifter included in the second transceiver, based on the first RF signal, the second RF signal, the third RF signal, and the fourth RF signal transmitted between the first RF chip and the second RF chip.

According to an embodiment, the method may further include an operation of controlling at least one of a first low noise amplifier (LNA) or a second phase shifter included in the first transceiver, based on the first RF signal of the second polarization and the second RF signal of the second polarization, and an operation of controlling at least one of a second LNA or a third phase shifter included in the third transceiver.

According to an embodiment, the method may include an operation of identifying first RF signals of the first polarization output from the first transceiver and received through a plurality of transceivers included in the first RF chip, respectively, an operation of identifying second RF signals of the first polarization output from the fifth transceiver included in the first RF chip and received through the plurality of transceivers, respectively, and an operation of identifying a relative phase value and/or a relative gain value between the first RF signals and the second RF signals, based on the first RF signals of the first polarization and the second RF signals of the first polarization. The plurality of transceivers may be disposed between the first transceiver and the fifth transceiver.

According to an embodiment, the method may include an operation of, based on the relative phase value and/or the relative gain value between the first RF signals and the second RF signals, controlling at least one of a second PA or a second phase shifter included in the first transceiver, or controlling at least one of a third PA or a third phase shifter included in the fifth transceiver, and an operation of controlling at least one of a plurality of PAs and a plurality of phase shifters included in the a plurality of transceivers, respectively.

According to an embodiment, a first frequency band supported by the first RF chip and a second frequency band supported by the second RF chip may overlap at least partially.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first radio frequency (RF) chip for transmitting and receiving RF signals, wherein the first RF chip comprises a first transceiver for transmitting RF signals having first polarization and a second transceiver for transmitting RF signals having second polarization;
a second RF chip for transmitting and receiving RF signals, wherein the second RF chip comprises a third transceiver for transmitting RF signals having the first polarization and a fourth transceiver for transmitting RF signals having the second polarization;
at least one connection line comprising at least one switch circuit, wherein the at least one connection line is configured to electrically connect the first RF chip and the second RF chip;
at least one processor; and
memory storing instructions that, when executed by the at least one processor individually or collectively, cause the electronic device to:
control the at least one switch circuit such that, through the at least one connection line, the first transceiver and the fourth transceiver are electrically connected, and the second transceiver and the third transceiver are electrically connected, and
control at least one of a first power amplifier (PA) or a first phase shifter included in the second transceiver, based on a first RF signal of the second polarization output from the fourth transceiver and received through the first transceiver, and a second RF signal of the second polarization output from the second transceiver and received through the third transceiver.

2. The electronic device of claim 1,
wherein the first RF chip further comprises a fifth transceiver for transmitting RF signals having the second polarization,
wherein the second RF chip further comprises a sixth transceiver for transmitting RF signals having the second polarization, and
wherein the instructions, when executed by the at least one processor individually or collectively, further cause the electronic device to:
electrically connect the first transceiver and the fifth transceiver and electrically connect the third transceiver and the sixth transceiver,
identify a third RF signal of the second polarization output from the fifth transceiver and received through the first transceiver, and a fourth RF signal of the second polarization output from the sixth transceiver and received through the third transceiver, and
control at least one of the first PA or the first phase shifter included in the second transceiver, based on the first RF signal, the second RF signal, the third RF signal, and the fourth RF signal transmitted between the first RF chip and the second RF chip.

3. The electronic device of claim 1, wherein the instructions, when executed by the at least one processor individually or collectively, further cause the electronic device to:
control at least one of a first low noise amplifier (LNA) or a second phase shifter included in the first transceiver, based on the first RF signal of the second polarization and the second RF signal of the second polarization, or
control at least one of a second LNA or a third phase shifter included in the third transceiver.

4. The electronic device of claim 1, wherein the instructions, when executed by the at least one processor individually or collectively, further cause the electronic device to, based on the first RF signal and the second RF signal:
identify a relative phase value of an RF signal output from the fourth transceiver with regard to a phase value an RF signal output from the second transceiver;
identify a relative gain value of an RF signal output from the fourth transceiver with regard to a gain value of an RF signal output from the second transceiver; and
control at least one of the first PA or the first phase shifter included in the second transceiver, based on the identified phase value and the gain value.

5. The electronic device of claim 1, wherein a first frequency band supported by the first RF chip and a second frequency band supported by the second RF chip overlap at least partially.

6. The electronic device of claim 1, further comprising:
a first mixer for the first polarization;
a second mixer for the second polarization; and
a local oscillator (LO) connected to the first mixer and the second mixer,
wherein the first mixer is connected to the first transceiver of the first RF chip and the third transceiver of the second RF chip and is configured to transmit RF signals of the first polarization to the first transceiver and the third transceiver, and
wherein the second mixer is connected to the second transceiver of the second RF chip and the fourth transceiver of the second RF chip and is configured to transmit RF signals of the second polarization to the second transceiver and the fourth transceiver.

7. The electronic device of claim 6, further comprising:
a circuit for detecting RF signals output from the first RF chip and the second RF chip,
wherein the circuit is configured to:
detect the first RF signal through the first transceiver, the third transceiver, and the second mixer, in case that the second mixer is connected to the circuit, and
detect the second RF signal through the second transceiver, the fourth transceiver, and the first mixer, in case that the first mixer is connected to the circuit.

8. The electronic device of claim 6, further comprising:
a first antenna array and a second antenna array each comprising a plurality of antenna elements,
wherein transceivers included in the first RF chip are configured to transmit RF signals of the first polarization received from the first mixer and RF signals of the second polarization received from the second mixer to the first antenna array, and
wherein transceivers included in the second RF chip are configured to transmit RF signals of the first polarization received from the first mixer and RF signals of the second polarization received from the second mixer to the second antenna array.

9. The electronic device of claim 1, wherein the first RF chip comprises:
a fifth transceiver for transmitting RF signals having the first polarization; and
a plurality of transceivers disposed between the first transceiver and the fifth transceiver and configured to transmit RF signals having the second polarization.

10. The electronic device of claim 9, wherein the instructions, when executed by the at least one processor individually or collectively, further cause the electronic device to:
identify first RF signals of the first polarization output from the first transceiver and received through the plurality of transceivers, respectively;
identify second RF signals of the first polarization output from the fifth transceiver and received through the plurality of transceivers, respectively; and
based on the first RF signals of the first polarization and the second RF signals of the first polarization:
identify a relative phase value and/or a relative gain value of an RF signal output from the fifth transceiver with regard to an RF signal output from the first transceiver, and
identify a relative phase value and/or a relative gain value of an RF signal output from one of the plurality of transceivers with regard to an RF signal output from another among the plurality of transceivers.

11. The electronic device of claim 10, wherein the instructions, when executed by the at least one processor individually or collectively, further cause the electronic device to, based on the relative phase value and/or the relative gain value of the RF signal output from the fifth transceiver with regard to the RF signal output from the first transceiver:
control at least one of a second PA or a second phase shifter included in the first transceiver, or
control at least one of a third PA or a third phase shifter included in the fifth transceiver.

12. The electronic device of claim 1, wherein the at least one connection line comprises:
a first coupler configured to capacitively connect the first transceiver and the at least one connection line; and
a second coupler configured to capacitively connect the second transceiver and the at least one connection line.

13. The electronic device of claim 1, wherein the first phase shifter of the second transceiver is selectively connected to the first PA or a low noise amplifier (LNA) included in the second transceiver.

14. The electronic device of claim 1, further comprising:
a printed circuit board,
wherein the at least one processor, the first RF chip, and the second RF chip are disposed on a first surface of the printed circuit board, and
wherein the at least one connection line is formed on the first surface of the printed circuit board for electrically connecting the first RF chip and the second RF chip.

15. A method performed by an electronic device in a wireless communication system, the method comprising:
controlling at least one switch such that a first transceiver and a second transceiver included in a first radio frequency (RF) chip are electrically connected to a third transceiver and a fourth transceiver included in a second RF chip, respectively, through at least one connection line included in the electronic device;
identifying a first RF signal of second polarization output from the fourth transceiver and received through the first transceiver, and a second RF signal of second polarization output from the second transceiver and received through the third transceiver; and
controlling one of a first power amplifier (PA) or a first phase shifter included in the second transceiver, based on the first RF signal and the second RF signal,
wherein the first transceiver and the third transceiver correspond to transceivers for transmitting and receiving RF signals having first polarization, and
wherein the second transceiver and the fourth transceiver correspond to transceivers for transmitting and receiving RF signals having the second polarization.

16. The method of claim 15,
wherein the first RF chip further comprises a fifth transceiver for transmitting RF signals having the second polarization,
wherein the second RF chip further comprises a sixth transceiver for transmitting RF signals having the second polarization, and
wherein the method further comprises:
electrically connecting the first transceiver and the fifth transceiver
electrically connecting the third transceiver and the sixth transceiver.

17. The method of claim 15, further comprising:
controlling at least one of a first low noise amplifier (LNA) or a second phase shifter included in the first transceiver, based on the first RF signal of the second polarization and the second RF signal of the second polarization, or
controlling at least one of a second LNA or a third phase shifter included in the third transceiver.

18. The method of claim 15, further comprising:
identifying a relative phase value of an RF signal output from the fourth transceiver with regard to a phase value an RF signal output from the second transceiver;
identifying a relative gain value of an RF signal output from the fourth transceiver with regard to a gain value of an RF signal output from the second transceiver; and
controlling at least one of the first PA or the first phase shifter included in the second transceiver, based on the identified phase value and the gain value.

19. The method of claim 15, wherein a first frequency band supported by the first RF chip and a second frequency band supported by the second RF chip overlap at least partially.

20. The method of claim 16, wherein a first frequency band supported by the first RF chip and a second frequency band supported by the second RF chip overlap at least partially.
